(19) United States
(12) Patent Application Publication
(10) Pub. No.: US 2014/0234513 A1
(43) Pub. Date: Aug. 21, 2014

(54) COMPOSITION

(71) Applicant: DUPONT NUTRITION BIOSCIENCES APS, Copenhagen K (DK)

(72) Inventors: Allan Torben Bech, Braband (DK); Mark Farmer, vaud Oron la Ville (CH); Brad Alexander Forrest, New South Wales (AU); Paul Wassell, East Sussex (GB); Niall W.G. Yong, Tjele (DK)

(73) Assignee: DUPONT NUTRITION BIOSCIENCES APS, Copenhagen K (DK)

(21) Appl. No.: 14/349,433

(22) PCT Filed: Oct. 3, 2012
(86) PCT No.: PCT/IB2012/055300

§ 371 Date: Apr. 3, 2014

(30) Foreign Application Priority Data
Oct. 4, 2011 (GB) 1117037.0

(51) Int. Cl. A23D 7/01

(52) U.S. Cl. CPC A23D 7/01
USPC 426/565; 426/607; 426/601; 426/602; 426/603

(57) ABSTRACT

The present invention provides a composition comprising monoglycerides and diglycerides, wherein the monoglycerides and diglycerides have an iodine value of at least 30; and wherein the fatty acids of the monoglycerides and diglycerides contain C22 fatty acids in an amount of at least 4.5 wt % based on the total amount of fatty acids of the monoglycerides and diglycerides.

### FIELD OF INVENTION

The present invention relates to a composition. In particular, the present invention relates to a composition containing monoglycerides and diglycerides. Yet further, the present invention relates to a food or feed comprising the composition.

### BACKGROUND

Mono and diglycerides of fatty acids, that is mono- or di-esters of fatty acids and glycerol, are materials commonly used in industry. In particular these materials are commonly used in the food and feed industry for a number of purposes. In particular, these materials may be used as emulsifiers to assist in the preparation of emulsions or as crystal formation modifiers which are contacted with fats to improve their crystallisation properties.

As is known to one skilled in the art, an emulsion is a colloid consisting of a stable mixture of two immiscible phases, typically liquid phases in which small droplets of one phase are dispersed uniformly throughout the other. A typical emulsion is an oil and water emulsion, such as a water-in-oil emulsion. Emulsions may, for example, be industrial emulsions such as water-containing crude oils emulsified by addition of surface active substances, or edible emulsions such as mayonnaise, salad cream or margarine.

Emulsions are typically stabilised by the addition of an emulsifier and many effective emulsifiers are known. Many frequently used emulsifiers are mono- or di-esters of fatty acids and glycerol. However, providing a source of suitable fatty acids having the desired fatty acid profile suitable for the application in which the mono- and diglycerides are to be used can be problematic. Fatty acids are typically provided from triglycerides and these are sourced from triglyceride oils of natural sources. Many well known sources of oils are plants, animals and fish. However, there is an increasing demand for certain of these oils and many oils are becoming unacceptable to consumers for ethical or health reasons. There is therefore a desire to provide monoglycerides prepared from source oils which are easily grown, not in high demand, are ethically acceptable and which have a fatty acid profile which provides for an effective emulsifier. Moreover even when suitable sources of fatty acids are identified if mono- and diglycerides are made directly from these sources then the “fatty acid profile” of the source material may not be suitable to provide a final glyceride having the desired properties. The profile of a fatty acid source may vary in respect of the chain length of the various fatty acids present and the degrees and points of unsaturation of the fatty acids present. Thus complex profiles of fatty acids are found both in respect of the chain lengths of the fatty acids and the degree and position of unsaturation.

As discussed above, esters of glycerol and fatty acids (glycerides and diglycerides) are also often used in the food and feed industry for improving the crystallisation properties of fats. In many application areas, the food and feed industry being one, it is desirable for the crystallisation of fats in a triglyceride to be controlled. This control may be in the form of enhancing the rate of crystallisation, enhancing the extent of crystallisation, slowing the rate of crystallisation, limiting the extent of crystallisation, modifying the conditions in which crystallisation occurs or favouring or preventing a particular crystal form. For this reason crystallisation enhancers are commonly used in the food and feed industry. A well-known and market leading crystallisation enhancer is GRINDSTED® Crystalliser 110, available from Danisco A/S, Denmark. GRINDSTED® Crystalliser 110 is a monoglyceride containing a high amount of saturated C22 (behenate). It is understood by those skilled in the art that materials such as GRINDSTED® Crystalliser 110 may act only as a crystallisation enhancer and not as an emulsifier. Therefore products such as these are used only in applications where crystallisation of triglycerides is a problem. Furthermore if an emulsifier is required in such systems, it must be added separately to the crystallisation enhancer. This is particularly the case in demanding applications such as low-fat (41% or less fat) spreads.

In view of the above, it would be desirable to provide a composition which can function as an emulsifier and which addresses the problems set out above. It would also be desirable to provide a composition which can function as both an emulsifier and a crystallisation improver.

### SUMMARY ASPECTS OF THE PRESENT INVENTION

In one aspect, the present invention provides a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

In one aspect, the present invention provides a food or feed comprising

(i) a foodstuff
(ii) a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

In one aspect, the present invention provides a process for preparing a food or feed, the process comprising the steps of

(i) providing a foodstuff
(ii) contacting the foodstuff with a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

In one aspect, the present invention provides an emulsifier consisting of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

In one aspect, the present invention provides a crystallisation improver consisting of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

In one aspect, the present invention provides a process for controlling the crystallisation of a triglyceride, the process comprising the steps of

(i) providing a triglyceride
(ii) contacting the triglyceride with a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

In one aspect, the present invention provides use of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides;

to prepare a food or feed.

In one aspect, the present invention provides a use of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides;

to control the crystallisation of a triglyceride.

In one aspect, the present invention provides use of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides;

to increase onset temperature of crystallisation of a triglyceride compared to the triglyceride in the absence of the composition comprising monoglycerides and diglycerides.

In one aspect, the present invention provides a process for preparing an emulsion, the process comprising the steps of

(i) providing a fat phase and an aqueous phase
(ii) contacting the fat phase and the aqueous phase in the presence of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides;

In one aspect, the present invention provides use of a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides;

to stabilise an oil and water emulsion.

It has been surprisingly found that by providing an ester of glycerol and fatty acids in which the fatty acids esterified to the glycerol have a reasonably high iodine value, namely an iodine value of at least 30, and contain fatty acids of 22 carbon atoms in length in a significant amount, namely at least 4.5% of the esterified fatty acids, a composition may be provided which acts as an effective crystallisation improver and/or acts as an effective emulsifier. This composition may be obtained by blending one or more sources of fatty acids to provide the desired iodine value and C22 content. Thus the composition may be prepared from a wide variety of fatty acid sources and thereby flexibility is provided in the choice of source material. Thus source materials may be selected based on, for example, availability or consumer acceptability.

### DETAILED DESCRIPTION

As discussed above, in one aspect, the present invention provides a composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

### Mono or Di Ester of Glycerol and Fatty Acids

It will be appreciated by one skilled in the art that references herein to monoglycerides and diglycerides relate to monoesters and diesters of glycerol and fatty acids. These are commonly referred to by those skilled in this art as monoglycerides (monoester of glycerol and fatty acids) and diglycerides (diester of glycerol and fatty acids).

The process for making mono- or di-esters of fatty acids and glycerol, in other words mono- and diglycerides are well known to the person skilled in the art. For example information can be found in “Emulsifiers in Food Technology”, Blackwell Publishing, edited by R. J. Whitehurst, page 40-58.

Mono- and diglycerides are generally produced by interesterification (glycerolysis) of triglycerides with glycerol, see fig. below:

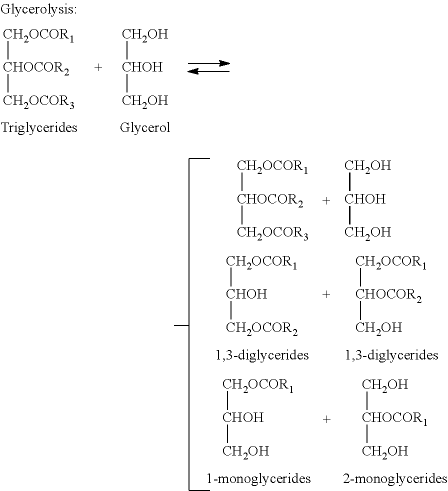

Triglycerides react with glycerol at high temperature (200-250° C.) under alkaline conditions, yielding a mixture of monoglycerides, diglycerides and triglycerides as well as unreacted glycerol. The content of monoglycerides varies typically from 10-60% depending on the glycerol/fat ratio. Alternatively mono- and diglycerides may also be prepared via direct esterification of glycerol with a fatty acid mixture.

If glycerol is removed from the mixture above by e.g. distillation, the resulting mixture of monoglycerides, diglycerides and triglycerides is often sold as a “mono-diglyceride” and used as such. Distilled monoglyceride may be separated from the mono-diglyceride by molecular or short path distillation.

It is a requirement of the present invention that the monoglycerides and diglycerides have an iodine value of at least 30. It will be understood that the monoglycerides and diglycerides present in the composition combined together have an iodine value of at least 30 (or the preferred ranges recited herein), it will be understood by one skilled in the art that it is not a requirement that each monoglyceride of the composition has an iodine value of at least 30 or that each diglyceride of the composition has an iodine value of at least 30. Iodine value may be determined readily by one skilled in the art. A standard method for determining iodine value is IUPAC Standard Method 2.205.

In one preferred aspect the monoglycerides and diglycerides have an iodine value of at least 35. In one preferred aspect the monoglycerides and diglycerides have an iodine value of at least 40. In one preferred aspect the monoglycerides and diglycerides have an iodine value of at least 45. In one preferred aspect the monoglycerides and diglycerides have an iodine value of at least 50. In one preferred aspect the monoglycerides and diglycerides have an iodine value of at least 55. In one preferred aspect the monoglycerides and diglycerides have an iodine value of at least 60. In one preferred aspect the monoglycerides and diglycerides have an iodine value of at least 65.

In one preferred aspect the monoglycerides and diglycerides have an iodine value of no greater than 90. In one preferred aspect the monoglycerides and diglycerides have an iodine value of no greater than 85. In one preferred aspect the monoglycerides and diglycerides have an iodine value of no greater than 80. In one preferred aspect the monoglycerides and diglycerides have an iodine value of no greater than 75. In one preferred aspect the monoglycerides and diglycerides have an iodine value of no greater than 70. In one preferred aspect the monoglycerides and diglycerides have an iodine value of no greater than 65.

In one preferred aspect the monoglycerides and diglycerides have an iodine value of from 30 to 90. In one preferred aspect the monoglycerides and diglycerides have an iodine value of from 30 to 85. In one preferred aspect the monoglycerides and diglycerides have an iodine value of from 30 to 80. In one preferred aspect the monoglycerides and diglycerides have an iodine value of from 30 to 75. In one preferred aspect the monoglycerides and diglycerides have an iodine value of from 30 to 70. In one preferred aspect the monoglycerides and diglycerides have an iodine value of from 32 to 71. In one preferred aspect the monoglycerides and diglycerides have an iodine value of from 32 to 70. In one preferred aspect the monoglycerides and diglycerides have an iodine value of from 35 to 85. In one preferred aspect the monoglycerides and diglycerides have an iodine value of from 40 to 85. In one preferred aspect the monoglycerides and diglycerides have an iodine value of from 45 to 80. In one preferred aspect the monoglycerides and diglycerides have an iodine value of from 50 to 75. In one preferred aspect the monoglycerides and diglycerides have an iodine value of from 55 to 70. In one preferred aspect the monoglycerides and diglycerides have an iodine value of from 60 to 70. In one preferred aspect the monoglycerides and diglycerides have an iodine value of from 65 to 70.

It will be appreciated by one skilled in the art that the above iodine values are measured or calculated based on the monoglycerides and diglycerides and based on the monoglycerides and diglycerides alone (i.e. in the absence of other materials). In one preferred aspect, the composition as a whole i.e. the composition of the present invention, has an iodine value as described above. Thus, in one preferred aspect the composition has an iodine value of at least 30. Thus, in one preferred aspect the composition has an iodine value of at least 35. In one preferred aspect the composition has an iodine value of at least 40. In one preferred aspect the composition has an iodine value of at least 45. In one preferred aspect the composition has an iodine value of at least 50. In one preferred aspect the composition has an iodine value of at least 55. In one preferred aspect the composition has an iodine value of at least 60. In one preferred aspect the composition has an iodine value of at least 65.

In one preferred aspect the composition has an iodine value of no greater than 90. In one preferred aspect the composition has an iodine value of no greater than 85. In one preferred aspect the composition has an iodine value of no greater than 80. In one preferred aspect the composition has an iodine value of no greater than 75. In one preferred aspect the composition has an iodine value of no greater than 70. In one preferred aspect the composition has an iodine value of no greater than 65.

In one preferred aspect the composition has an iodine value of from 30 to 90. In one preferred aspect the composition has an iodine value of from 35 to 85. In one preferred aspect the composition has an iodine value of from 40 to 85. In one preferred aspect the composition has an iodine value of from 45 to 80. In one preferred aspect the composition has an iodine value of from 50 to 75. In one preferred aspect the composition has an iodine value of from 55 to 70. In one preferred aspect the composition has an iodine value of from 60 to 70. In one preferred aspect the composition has an iodine value of from 65 to 70.

As discussed, the fatty acids of the monoglycerides and diglycerides contain C22 fatty acids in an amount of at least 4.5 wt % based on the total amount of fatty acids of the monoglycerides and diglycerides. It will be understood that “the fatty acids of the monoglycerides and diglycerides” refers to fatty acids which are esterified to glycerol. This does not include any free fatty acids, fatty acids attached to glycerol as triglycerides or fatty acids attached to moieties other than glycerol.

The C22 fatty acids referred to and measured is the combined amount of all fatty acids having a straight chain length of 22 carbons irrespective of saturation or unsaturation

In one preferred aspect the fatty acids of the monoglycerides and diglycerides contain C22 fatty acids in an amount of at least 5.0 wt % based on the total amount of fatty acids of the monoglycerides and diglycerides. In one preferred aspect the fatty acids of the monoglycerides and diglycerides contain C22 fatty acids in an amount of at least 5.5 wt % based on the total amount of fatty acids of the monoglycerides and diglycerides. In one preferred aspect the fatty acids of the monoglycerides and diglycerides contain C22 fatty acids in an amount of at least 6.0 wt % based on the total amount of fatty acids of the monoglycerides and diglycerides. In one preferred aspect the fatty acids of the monoglycerides and diglycerides contain C22 fatty acids in an amount of at least 6.5 wt % based on the total amount of fatty acids of the monoglycerides and diglycerides. In one preferred aspect the fatty acids of the monoglycerides and diglycerides contain C22 fatty acids in an amount of at least 7.0 wt % based on the total amount of fatty acids of the monoglycerides and diglycerides. In one preferred aspect the fatty acids of the monoglycerides and diglycerides contain C22 fatty acids in an amount of at least 7.5 wt % based on the total amount of fatty acids of the monoglycerides and diglycerides. In one preferred aspect the fatty acids of the monoglycerides and diglycerides contain C22 fatty acids in an amount of at least 8.0 wt % based on the total amount of fatty acids of the monoglycerides and diglycerides. In one preferred aspect the fatty acids of the monoglycerides and diglycerides contain C22 fatty acids in an amount of at least 8.5 wt % based on the total amount of fatty acids of the monoglycerides and diglycerides. In one preferred aspect the fatty acids of the monoglycerides and diglycerides contain C22 fatty acids in an amount of at least 9.0 wt % based on the total amount of fatty acids of the monoglycerides and diglycerides. In one preferred aspect the fatty acids of the monoglycerides and diglycerides contain C22 fatty acids in an amount of at least 9.5 wt % based on the total amount of fatty acids of the monoglycerides and diglycerides. In one preferred aspect the fatty acids of the monoglycerides and diglycerides contain C22 fatty acids in an amount of at least 10.0 wt % based on the total amount of fatty acids of the monoglycerides and diglycerides. In one preferred aspect the fatty acids of the monoglycerides and diglycerides contain C22 fatty acids in an amount of at least 10.5 wt % based on the total amount of fatty acids of the monoglycerides and diglycerides. In one preferred aspect the fatty acids of the monoglycerides and diglycerides contain C22 fatty acids in an amount of at least 12.5 wt % based on the total amount of fatty acids of the monoglycerides and diglycerides. In one preferred aspect the fatty acids of the monoglycerides and diglycerides contain C22 fatty acids in an amount of at least 15.0 wt % based on the total amount of fatty acids of the monoglycerides and diglycerides. In one preferred aspect the fatty acids of the monoglycerides and diglycerides contain C22 fatty acids in an amount of at least 17.5 wt % based on the total amount of fatty acids of the monoglycerides and diglycerides. In one preferred aspect the fatty acids of the monoglycerides and diglycerides contain C22 fatty acids in an amount of at least 20.0 wt % based on the total amount of fatty acids of the monoglycerides and diglycerides. In one preferred aspect the fatty acids of the monoglycerides and diglycerides contain C22 fatty acids in an amount of at least 22.5 wt % based on the total amount of fatty acids of the monoglycerides and diglycerides. In one preferred aspect the fatty acids of the monoglycerides and diglycerides contain C22 fatty acids in an amount of at least 25.0 wt % based on the total amount of fatty acids of the monoglycerides and diglycerides. In one preferred aspect the fatty acids of the monoglycerides and diglycerides contain C22 fatty acids in an amount of at least 27.5 wt % based on the total amount of fatty acids of the monoglycerides and diglycerides. In one preferred aspect the fatty acids of the monoglycerides and diglycerides contain C22 fatty acids in an amount of at least 30.0 wt % based on the total amount of fatty acids of the monoglycerides and diglycerides.

In one preferred aspect the fatty acids of the monoglycerides and diglycerides contain C22 fatty acids in an amount of at least 7 wt % based on the total amount of fatty acids of the monoglycerides and diglycerides. We have found that providing the C22 fatty acids in an amount of at least 7 weight percent, the monoglyceride and diglyceride composition may be used in a wide range of food applications. Although compositions containing from 4.5 to 7 wt % may be used in many food application areas and are therefore advantageous, further advantages are provided by a composition containing C22 fatty acids in an amount of at least 7 wt % C22 fatty acids based on the total amount of fatty acids of the monoglycerides and diglycerides.

In one preferred aspect the fatty acids of the monoglycerides and diglycerides contain C22 fatty acids in an amount of no greater than 90 wt % based on the total amount of fatty acids of the monoglycerides and diglycerides. In one preferred aspect the fatty acids of the monoglycerides and diglycerides contain C22 fatty acids in an amount of no greater than 85 wt % based on the total amount of fatty acids of the monoglycerides and diglycerides. In one preferred aspect the fatty acids of the monoglycerides and diglycerides contain C22 fatty acids in an amount of no greater than 80 wt % based on the total amount of fatty acids of the monoglycerides and diglycerides. In one preferred aspect the fatty acids of the monoglycerides and diglycerides contain C22 fatty acids in an amount of no greater than 75 wt % based on the total amount of fatty acids of the monoglycerides and diglycerides. In one preferred aspect the fatty acids of the monoglycerides and diglycerides contain C22 fatty acids in an amount of no greater than 70 wt % based on the total amount of fatty acids of the monoglycerides and diglycerides. In one preferred aspect the fatty acids of the monoglycerides and diglycerides contain C22 fatty acids in an amount of no greater than 65 wt % based on the total amount of fatty acids of the monoglycerides and diglycerides. In one preferred aspect the fatty acids of the monoglycerides and diglycerides contain C22 fatty acids in an amount of no greater than 60 wt % based on the total amount of fatty acids of the monoglycerides and diglycerides. In one preferred aspect the fatty acids of the monoglycerides and diglycerides contain C22 fatty acids in an amount of no greater than 55 wt % based on the total amount of fatty acids of the monoglycerides and diglycerides. In one preferred aspect the fatty acids of the monoglycerides and diglycerides contain C22 fatty acids in an amount of no greater than 50 wt % based on the total amount of fatty acids of the monoglycerides and diglycerides. In one preferred aspect the fatty acids of the monoglycerides and diglycerides contain C22 fatty acids in an amount of no greater than 45 wt % based on the total amount of fatty acids of the monoglycerides and diglycerides. In one preferred aspect the fatty acids of the monoglycerides and diglycerides contain C22 fatty acids in an amount of no greater than 40 wt % based on the total amount of fatty acids of the monoglycerides and diglycerides. In one preferred aspect the fatty acids of the monoglycerides and diglycerides contain C22 fatty acids in an amount of no greater than 37.5 wt % based on the total amount of fatty acids of the monoglycerides and diglycerides. In one preferred aspect the fatty acids of the monoglycerides and diglycerides contain C22 fatty acids in an amount of no greater than 35 wt % based on the total amount of fatty acids of the monoglycerides and diglycerides. In one preferred aspect the fatty acids of the monoglycerides and diglycerides contain C22 fatty acids in an amount of no greater than 32.5 wt % based on the total amount of fatty acids of the monoglycerides and diglycerides. In one preferred aspect the fatty acids of the monoglycerides and diglycerides contain C22 fatty acids in an amount of no greater than 31 wt % based on the total amount of fatty acids of the monoglycerides and diglycerides.

In one preferred aspect the fatty acids of the monoglycerides and diglycerides contain C22 fatty acids in an amount of from 4.5 wt % to 90 wt % based on the total amount of fatty acids of the monoglycerides and diglycerides. In one preferred aspect the fatty acids of the monoglycerides and diglycerides contain C22 fatty acids in an amount of from 5.0 wt % to 90 wt % based on the total amount of fatty acids of the monoglycerides and diglycerides. In one preferred aspect the fatty acids of the monoglycerides and diglycerides contain C22 fatty acids in an amount of from 5.5 wt % to 90 wt % based on the total amount of fatty acids of the monoglycerides and diglycerides. In one preferred aspect the fatty acids of the monoglycerides and diglycerides contain C22 fatty acids in an amount of from 6.0 wt % to 90 wt % based on the total amount of fatty acids of the monoglycerides and diglycerides. In one preferred aspect the fatty acids of the monoglycerides and diglycerides contain C22 fatty acids in an amount of from 6.5 wt % to 90 wt % based on the total amount of fatty acids of the monoglycerides and diglycerides. In one preferred aspect the fatty acids of the monoglycerides and diglycerides contain C22 fatty acids in an amount of from 7.0 wt % to 90 wt % based on the total amount of fatty acids of the monoglycerides and diglycerides. In one preferred aspect the fatty acids of the monoglycerides and diglycerides contain C22 fatty acids in an amount of from 7.5 wt % to 85 wt % based on the total amount of fatty acids of the monoglycerides and diglycerides. In one preferred aspect the fatty acids of the monoglycerides and diglycerides contain C22 fatty acids in an amount of from 8.0 wt % to 80 wt % based on the total amount of fatty acids of the monoglycerides and diglycerides. In one preferred aspect the fatty acids of the monoglycerides and diglycerides contain C22 fatty acids in an amount of from 8.5 wt % to 75 wt % based on the total amount of fatty acids of the monoglycerides and diglycerides. In one preferred aspect the fatty acids of the monoglycerides and diglycerides contain C22 fatty acids in an amount of from 9.0 wt % to 70 wt % based on the total amount of fatty acids of the monoglycerides and diglycerides. In one preferred aspect the fatty acids of the monoglycerides and diglycerides contain C22 fatty acids in an amount of from 9.5 wt % to 65 wt % based on the total amount of fatty acids of the monoglycerides and diglycerides. In one preferred aspect the fatty acids of the monoglycerides and diglycerides contain C22 fatty acids in an amount of from 10.0 wt % to 60 wt % based on the total amount of fatty acids of the monoglycerides and diglycerides. In one preferred aspect the fatty acids of the monoglycerides and diglycerides contain C22 fatty acids in an amount of from 10.0 wt % to 55 wt % based on the total amount of fatty acids of the monoglycerides and diglycerides. In one preferred aspect the fatty acids of the monoglycerides and diglycerides contain C22 fatty acids in an amount of from 10.0 wt % to 50 wt % based on the total amount of fatty acids of the monoglycerides and diglycerides. In one preferred aspect the fatty acids of the monoglycerides and diglycerides contain C22 fatty acids in an amount of from 10.0 wt % to 45 wt % based on the total amount of fatty acids of the monoglycerides and diglycerides. In one preferred aspect the fatty acids of the monoglycerides and diglycerides contain C22 fatty acids in an amount of from 10.0 wt % to 40 wt % based on the total amount of fatty acids of the monoglycerides and diglycerides. In one preferred aspect the fatty acids of the monoglycerides and diglycerides contain C22 fatty acids in an amount of from 10.0 wt % to 37.5 wt % based on the total amount of fatty acids of the monoglycerides and diglycerides. In one preferred aspect the fatty acids of the monoglycerides and diglycerides contain C22 fatty acids in an amount of from 10.0 wt % to 35 wt % based on the total amount of fatty acids of the monoglycerides and diglycerides. In one preferred aspect the fatty acids of the monoglycerides and diglycerides contain C22 fatty acids in an amount of from 10.0 wt % to 32.5 wt % based on the total amount of fatty acids of the monoglycerides and diglycerides. In one preferred aspect the fatty acids of the monoglycerides and diglycerides contain C22 fatty acids in an amount of from 10.0 wt % to 32 wt % based on the total amount of fatty acids of the monoglycerides and diglycerides. In one preferred aspect the fatty acids of the monoglycerides and diglycerides contain C22 fatty acids in an amount of from 10.0 wt % to 31 wt % based on the total amount of fatty acids of the monoglycerides and diglycerides.

In one preferred aspect some or all of the C22 fatty acid groups present are saturated C22 fatty acids. In one preferred aspect saturated C22 fatty acid groups provide at least 70 wt % of the C22 fatty acids of the mono- and diglycerides. In one preferred aspect saturated C22 fatty acid groups provide at least 75 wt % of the C22 fatty acids of the mono- and diglycerides. In one preferred aspect saturated C22 fatty acid groups provide at least 80 wt % of the C22 fatty acids of the mono- and diglycerides. In one preferred aspect saturated C22 fatty acid groups provide at least 85 wt % of the C22 fatty acids of the mono- and diglycerides. In one preferred aspect saturated C22 fatty acid groups provide at least 90 wt % of the C22 fatty acids of the mono- and diglycerides. In one preferred aspect saturated C22 fatty acid groups provide at least 95 wt % of the C22 fatty acids of the mono- and diglycerides. In one preferred aspect substantially all of the C22 fatty acids of the mono- and diglycerides are saturated C22 fatty acid groups.

In one preferred aspect the fatty acids of the monoglycerides and diglycerides contain saturated C22 fatty acids in an amount of at least 4.5 wt % based on the total amount of fatty acids of the monoglycerides and diglycerides. In one preferred aspect the fatty acids of the monoglycerides and diglycerides contain saturated C22 fatty acids in an amount of at least 5.0 wt % based on the total amount of fatty acids of the monoglycerides and diglycerides. In one preferred aspect the fatty acids of the monoglycerides and diglycerides contain saturated C22 fatty acids in an amount of at least 5.5 wt % based on the total amount of fatty acids of the monoglycerides and diglycerides. In one preferred aspect the fatty acids of the monoglycerides and diglycerides contain saturated C22 fatty acids in an amount of at least 6.0 wt % based on the total amount of fatty acids of the monoglycerides and diglycerides. In one preferred aspect the fatty acids of the monoglycerides and diglycerides contain saturated C22 fatty acids in an amount of at least 6.5 wt % based on the total amount of fatty acids of the monoglycerides and diglycerides. In one preferred aspect the fatty acids of the monoglycerides and diglycerides contain saturated C22 fatty acids in an amount of at least 7.0 wt % based on the total amount of fatty acids of the monoglycerides and diglycerides. In one preferred aspect the fatty acids of the monoglycerides and diglycerides contain saturated C22 fatty acids in an amount of at least 7.5 wt % based on the total amount of fatty acids of the monoglycerides and diglycerides. In one preferred aspect the fatty acids of the monoglycerides and diglycerides contain saturated C22 fatty acids in an amount of at least 8.0 wt % based on the total amount of fatty acids of the monoglycerides and diglycerides. In one preferred aspect the fatty acids of the monoglycerides and diglycerides contain saturated C22 fatty acids in an amount of at least 8.5 wt % based on the total amount of fatty acids of the monoglycerides and diglycerides. In one preferred aspect the fatty acids of the monoglycerides and diglycerides contain saturated C22 fatty acids in an amount of at least 9.0 wt % based on the total amount of fatty acids of the monoglycerides and diglycerides. In one preferred aspect the fatty acids of the monoglycerides and diglycerides contain saturated C22 fatty acids in an amount of at least 9.5 wt % based on the total amount of fatty acids of the monoglycerides and diglycerides. In one preferred aspect the fatty acids of the monoglycerides and diglycerides contain saturated C22 fatty acids in an amount of at least 10.0 wt % based on the total amount of fatty acids of the monoglycerides and diglycerides. In one preferred aspect the fatty acids of the monoglycerides and diglycerides contain saturated C22 fatty acids in an amount of at least 10.5 wt % based on the total amount of fatty acids of the monoglycerides and diglycerides. In one preferred aspect the fatty acids of the monoglycerides and diglycerides contain saturated C22 fatty acids in an amount of at least 12.5 wt % based on the total amount of fatty acids of the monoglycerides and diglycerides. In one preferred aspect the fatty acids of the monoglycerides and diglycerides contain saturated C22 fatty acids in an amount of at least 15.0 wt % based on the total amount of fatty acids of the monoglycerides and diglycerides. In one preferred aspect the fatty acids of the monoglycerides and diglycerides contain saturated C22 fatty acids in an amount of at least 17.5 wt % based on the total amount of fatty acids of the monoglycerides and diglycerides. In one preferred aspect the fatty acids of the monoglycerides and diglycerides contain saturated C22 fatty acids in an amount of at least 20.0 wt % based on the total amount of fatty acids of the monoglycerides and diglycerides. In one preferred aspect the fatty acids of the monoglycerides and diglycerides contain saturated C22 fatty acids in an amount of at least 22.5 wt % based on the total amount of fatty acids of the monoglycerides and diglycerides. In one preferred aspect the fatty acids of the monoglycerides and diglycerides contain saturated C22 fatty acids in an amount of at least 25.0 wt % based on the total amount of fatty acids of the monoglycerides and diglycerides. In one preferred aspect the fatty acids of the monoglycerides and diglycerides contain saturated C22 fatty acids in an amount of at least 27.5 wt % based on the total amount of fatty acids of the monoglycerides and diglycerides. In one preferred aspect the fatty acids of the monoglycerides and diglycerides contain saturated C22 fatty acids in an amount of at least 30.0 wt % based on the total amount of fatty acids of the monoglycerides and diglycerides.

In one preferred aspect the fatty acids of the monoglycerides and diglycerides contain saturated C22 fatty acids in an amount of no greater than 90 wt % based on the total amount of fatty acids of the monoglycerides and diglycerides. In one preferred aspect the fatty acids of the monoglycerides and diglycerides contain saturated C22 fatty acids in an amount of no greater than 85 wt % based on the total amount of fatty acids of the monoglycerides and diglycerides. In one preferred aspect the fatty acids of the monoglycerides and diglycerides contain saturated C22 fatty acids in an amount of no greater than 80 wt % based on the total amount of fatty acids of the monoglycerides and diglycerides. In one preferred aspect the fatty acids of the monoglycerides and diglycerides contain saturated C22 fatty acids in an amount of no greater than 75 wt % based on the total amount of fatty acids of the monoglycerides and diglycerides. In one preferred aspect the fatty acids of the monoglycerides and diglycerides contain saturated C22 fatty acids in an amount of no greater than 70 wt % based on the total amount of fatty acids of the monoglycerides and diglycerides. In one preferred aspect the fatty acids of the monoglycerides and diglycerides contain saturated C22 fatty acids in an amount of no greater than 65 wt % based on the total amount of fatty acids of the monoglycerides and diglycerides. In one preferred aspect the fatty acids of the monoglycerides and diglycerides contain saturated C22 fatty acids in an amount of no greater than 60 wt % based on the total amount of fatty acids of the monoglycerides and diglycerides. In one preferred aspect the fatty acids of the monoglycerides and diglycerides contain saturated C22 fatty acids in an amount of no greater than 55 wt % based on the total amount of fatty acids of the monoglycerides and diglycerides. In one preferred aspect the fatty acids of the monoglycerides and diglycerides contain saturated C22 fatty acids in an amount of no greater than 50 wt % based on the total amount of fatty acids of the monoglycerides and diglycerides. In one preferred aspect the fatty acids of the monoglycerides and diglycerides contain saturated C22 fatty acids in an amount of no greater than 45 wt % based on the total amount of fatty acids of the monoglycerides and diglycerides. In one preferred aspect the fatty acids of the monoglycerides and diglycerides contain saturated C22 fatty acids in an amount of no greater than 40 wt % based on the total amount of fatty acids of the monoglycerides and diglycerides. In one preferred aspect the fatty acids of the monoglycerides and diglycerides contain saturated C22 fatty acids in an amount of no greater than 37.5 wt % based on the total amount of fatty acids of the monoglycerides and diglycerides. In one preferred aspect the fatty acids of the monoglycerides and diglycerides contain saturated C22 fatty acids in an amount of no greater than 35 wt % based on the total amount of fatty acids of the monoglycerides and diglycerides. In one preferred aspect the fatty acids of the monoglycerides and diglycerides contain saturated C22 fatty acids in an amount of no greater than 32.5 wt % based on the total amount of fatty acids of the monoglycerides and diglycerides. In one preferred aspect the fatty acids of the monoglycerides and diglycerides contain saturated C22 fatty acids in an amount of no greater than 31 wt % based on the total amount of fatty acids of the monoglycerides and diglycerides.

In one preferred aspect the fatty acids of the monoglycerides and diglycerides contain saturated C22 fatty acids in an amount of from 4.5 wt % to 90 wt % based on the total amount of fatty acids of the monoglycerides and diglycerides. In one preferred aspect the fatty acids of the monoglycerides and diglycerides contain saturated C22 fatty acids in an amount of from 5.0 wt % to 90 wt % based on the total amount of fatty acids of the monoglycerides and diglycerides. In one preferred aspect the fatty acids of the monoglycerides and diglycerides contain saturated C22 fatty acids in an amount of from 5.5 wt % to 90 wt % based on the total amount of fatty acids of the monoglycerides and diglycerides. In one preferred aspect the fatty acids of the monoglycerides and diglycerides contain saturated C22 fatty acids in an amount of from 6.0 wt % to 90 wt % based on the total amount of fatty acids of the monoglycerides and diglycerides. In one preferred aspect the fatty acids of the monoglycerides and diglycerides contain saturated C22 fatty acids in an amount of from 6.5 wt % to 90 wt % based on the total amount of fatty acids of the monoglycerides and diglycerides. In one preferred aspect the fatty acids of the monoglycerides and diglycerides contain saturated C22 fatty acids in an amount of from 7.0 wt % to 90 wt % based on the total amount of fatty acids of the monoglycerides and diglycerides. In one preferred aspect the fatty acids of the monoglycerides and diglycerides contain saturated C22 fatty acids in an amount of from 7.5 wt % to 85 wt % based on the total amount of fatty acids of the monoglycerides and diglycerides. In one preferred aspect the fatty acids of the monoglycerides and diglycerides contain saturated C22 fatty acids in an amount of from 8.0 wt % to 80 wt % based on the total amount of fatty acids of the monoglycerides and diglycerides. In one preferred aspect the fatty acids of the monoglycerides and diglycerides contain saturated C22 fatty acids in an amount of from 8.5 wt % to 75 wt % based on the total amount of fatty acids of the monoglycerides and diglycerides. In one preferred aspect the fatty acids of the monoglycerides and diglycerides contain saturated C22 fatty acids in an amount of from 9.0 wt % to 70 wt % based on the total amount of fatty acids of the monoglycerides and diglycerides. In one preferred aspect the fatty acids of the monoglycerides and diglycerides contain saturated C22 fatty acids in an amount of from 9.5 wt % to 65 wt % based on the total amount of fatty acids of the monoglycerides and diglycerides. In one preferred aspect the fatty acids of the monoglycerides and diglycerides contain saturated C22 fatty acids in an amount of from 10.0 wt % to 60 wt % based on the total amount of fatty acids of the monoglycerides and diglycerides. In one preferred aspect the fatty acids of the monoglycerides and diglycerides contain saturated C22 fatty acids in an amount of from 10.0 wt % to 55 wt % based on the total amount of fatty acids of the monoglycerides and diglycerides. In one preferred aspect the fatty acids of the monoglycerides and diglycerides contain saturated C22 fatty acids in an amount of from 10.0 wt % to 50 wt % based on the total amount of fatty acids of the monoglycerides and diglycerides. In one preferred aspect the fatty acids of the monoglycerides and diglycerides contain saturated C22 fatty acids in an amount of from 10.0 wt % to 45 wt % based on the total amount of fatty acids of the monoglycerides and diglycerides. In one preferred aspect the fatty acids of the monoglycerides and diglycerides contain saturated C22 fatty acids in an amount of from 10.0 wt % to 40 wt % based on the total amount of fatty acids of the monoglycerides and diglycerides. In one preferred aspect the fatty acids of the monoglycerides and diglycerides contain saturated C22 fatty acids in an amount of from 10.0 wt % to 37.5 wt % based on the total amount of fatty acids of the monoglycerides and diglycerides. In one preferred aspect the fatty acids of the monoglycerides and diglycerides contain saturated C22 fatty acids in an amount of from 10.0 wt % to 35 wt % based on the total amount of fatty acids of the monoglycerides and diglycerides. In one preferred aspect the fatty acids of the monoglycerides and diglycerides contain saturated C22 fatty acids in an amount of from 10.0 wt % to 32.5 wt % based on the total amount of fatty acids of the monoglycerides and diglycerides. In one preferred aspect the fatty acids of the monoglycerides and diglycerides contain saturated C22 fatty acids in an amount of from 10.0 wt % to 32 wt % based on the total amount of fatty acids of the monoglycerides and diglycerides. In one preferred aspect the fatty acids of the monoglycerides and diglycerides contain saturated C22 fatty acids in an amount of from 10.0 wt % to 31 wt % based on the total amount of fatty acids of the monoglycerides and diglycerides.

The fatty acids of the monoglycerides and diglycerides may contain C18:1 fatty acids. C18:1 fatty acids are fatty acids of 18 carbon atoms in length having a single degree of unsaturation. A preferred C18:1 fatty acid is oleic acid ((9Z)-Octadec-9-enoic acid).

In one preferred aspect the fatty acids of the monoglycerides and diglycerides contain C18:1 fatty acids (preferably oleic acid) in an amount of no greater than 71 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 70 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 69 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 68 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 67 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 66 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 65 wt % based on the total amount of fatty acids of the monoglycerides and diglycerides. In one preferred aspect the fatty acids of the monoglycerides and diglycerides contain C18:1 fatty acids (preferably oleic acid) in an amount of no greater than 64.6 wt % based on the total amount of fatty acids of the monoglycerides and diglycerides.

In one preferred aspect the fatty acids of the monoglycerides and diglycerides contain C18:1 fatty acids (preferably oleic acid) in an amount of at least 5 wt % based on the total amount of fatty acids of the monoglycerides and diglycerides. In one preferred aspect the fatty acids of the monoglycerides and diglycerides contain C18:1 fatty acids (preferably oleic acid) in an amount of at least 10 wt % based on the total amount of fatty acids of the monoglycerides and diglycerides. In one preferred aspect the fatty acids of the monoglycerides and diglycerides contain C18:1 fatty acids (preferably oleic acid) in an amount of at least 15 wt % based on the total amount of fatty acids of the monoglycerides and diglycerides. In one preferred aspect the fatty acids of the monoglycerides and diglycerides contain C18:1 fatty acids (preferably oleic acid) in an amount of at least 20 wt % based on the total amount of fatty acids of the monoglycerides and diglycerides. In one preferred aspect the fatty acids of the monoglycerides and diglycerides contain C18:1 fatty acids (preferably oleic acid) in an amount of at least 25 wt % based on the total amount of fatty acids of the monoglycerides and diglycerides. In one preferred aspect the fatty acids of the monoglycerides and diglycerides contain C18:1 fatty acids (preferably oleic acid) in an amount of at least 30 wt % based on the total amount of fatty acids of the monoglycerides and diglycerides. In one preferred aspect the fatty acids of the monoglycerides and diglycerides contain C18:1 fatty acids (preferably oleic acid) in an amount of at least 35 wt % based on the total amount of fatty acids of the monoglycerides and diglycerides. In one preferred aspect the fatty acids of the monoglycerides and diglycerides contain C18:1 fatty acids (preferably oleic acid) in an amount of at least 40 wt % based on the total amount of fatty acids of the monoglycerides and diglycerides. In one preferred aspect the fatty acids of the monoglycerides and diglycerides contain C18:1 fatty acids (preferably oleic acid) in an amount of at least 45 wt % based on the total amount of fatty acids of the monoglycerides and diglycerides. In one preferred aspect the fatty acids of the monoglycerides and diglycerides contain C18:1 fatty acids (preferably oleic acid) in an amount of at least 47.6 wt % based on the total amount of fatty acids of the monoglycerides and diglycerides.

The fatty acids of the monoglycerides and diglycerides may contain C16:1 fatty acids. C16:1 fatty acids are fatty acids of 16 carbon atoms in length having a single degree of unsaturation. A preferred C16:1 fatty acid is sapienic acid ((Z)-6-Hexadecenoic acid).

In one preferred aspect the fatty acids of the monoglycerides and diglycerides contain C16:1 fatty acids (preferably sapienic acid) in an amount of no greater than 1.7 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 1.5 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 1.3 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 1.1 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 0.9 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 0.7 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 0.5 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 0.3 wt % based on the total amount of fatty acids of the monoglycerides and diglycerides. In one preferred aspect the fatty acids of the monoglycerides and diglycerides contain C16:1 fatty acids (preferably sapienic acid) in an amount of no greater than 0.2 wt % based on the total amount of fatty acids of the monoglycerides and diglycerides.

In one preferred aspect the fatty acids of the monoglycerides and diglycerides contain C16:1 fatty acids (preferably sapienic acid) in an amount of at least 0.001% based on the total amount of fatty acids of the monoglycerides and diglycerides. In one preferred aspect the fatty acids of the monoglycerides and diglycerides contain C16:1 fatty acids (preferably sapienic acid) in an amount of at least 0.005 wt % based on the total amount of fatty acids of the monoglycerides and diglycerides. In one preferred aspect the fatty acids of the monoglycerides and diglycerides contain C16:1 fatty acids (preferably sapienic acid) in an amount of at least 0.01 wt % based on the total amount of fatty acids of the monoglycerides and diglycerides. In one preferred aspect the fatty acids of the monoglycerides and diglycerides contain C16:1 fatty acids (preferably sapienic acid) in an amount of at least 0.02 wt % based on the total amount of fatty acids of the monoglycerides and diglycerides. In one preferred aspect the fatty acids of the monoglycerides and diglycerides contain C16:1 fatty acids (preferably sapienic acid) in an amount of at least 0.05 wt % based on the total amount of fatty acids of the monoglycerides and diglycerides. In one preferred aspect the fatty acids of the monoglycerides and diglycerides contain C16:1 fatty acids (preferably sapienic acid) in an amount of at least 0.075 wt % based on the total amount of fatty acids of the monoglycerides and diglycerides. In one preferred aspect the fatty acids of the monoglycerides and diglycerides contain C16:1 fatty acids (preferably sapienic acid) in an amount of at least 0.1 wt % based on the total amount of fatty acids of the monoglycerides and diglycerides.

### Food or Feed

In addition to providing the composition described herein, the present invention provides a food or feed comprising (i) a foodstuff; and (ii) composition comprising monoglycerides and diglycerides as described herein. The present invention also provides a process for preparing a food or feed, the process comprising the steps of (i) providing a foodstuff (ii) contacting the foodstuff with a composition as described herein. The present invention also provides use of a composition comprising monoglycerides and diglycerides as described herein to prepare a food or feed.

According to the present invention, “food” refers an edible material suitable for human consumption. According to the present invention, “feed” refers an edible material suitable for non-human animal consumption.

In one aspect the food or feed is a food. In one aspect the food or feed is a feed

The foodstuff may be solid or liquid. In some cases, the foodstuff may transform during cooking from a solid to a liquid. Furthermore, foodstuffs comprising a combination of liquid and solid components are also encompassed by the present invention.

Examples of foodstuffs in which the present invention may be employed include, but are not limited to spreads, bakery margarine, cake margarine, cake batter, chocolate, compound chocolate, ice cream, liquid bread improvers, whipped frozen desserts, ice cream, beverages including cola drinks, sausages, burgers, reconstituted meat, reconstituted fish, non-emulsified salad dressings, extruded foodstuffs including tortilla chips, breakfast cereals and corn snacks; biscuits, baked goods including breads and pastries, anhydrous dispersions and semi-solid food products.

In one embodiment, the foodstuff is selected from the group consisting of spreads, bakery margarine, cake margarine, cake batter, chocolate, compound chocolate, ice cream, liquid bread improvers. More preferably the foodstuff is selected from chocolate and compound chocolate. In one preferred aspect the foodstuff is selected from whipped frozen desserts. In a particularly preferred aspect the whipped frozen dessert is an ice cream. It is understood that the present emulsifier provides whipped frozen desserts and ice cream in particular which may have improved eating quality and has improved aging properties, that is aging has a less detrimental impact on the ice cream, for example ice crystal growth is minimised during aging.

In one embodiment, the food or feed is selected from a combination of one or more foodstuffs.

The mono- or di-ester of glycerol and fatty acids has emulsifying properties. However, it is not essential that the food or feed be an emulsion. For example, there are certain application areas where emulsifiers are desired but the food stuff itself is not an emulsion. Examples of these are beverages including cola drinks, sausages, burgers, reconstituted meat, reconstituted fish, non-emulsified salad dressings, extruded foodstuffs including tortilla chips, breakfast cereals and corn snacks; biscuits, baked goods including breads and pastries, anhydrous dispersions and semi-solid food products such as tahini(a), ghee, vanaspati, peanut butter and peanut paste, praline and hazelnut spread. The products of the present invention are capable of stabilizing the dispersion when crystallized fat particles are present as in ghee and vanaspati, and are capable of stabilizing oil separation and protein as in the case of peanut butter and peanut paste, praline and hazelnut spread. However, emulsifiers are typically used to prepare emulsions and in one preferred aspect, the present invention provides a food or feed wherein the food or feed is an emulsion. The emulsion may be a single emulsion, such as an oil in water emulsion or a water in oil emulsion. Further the emulsion may be a double emulsion, such as an oil in water in oil emulsion or a water in oil in water emulsion

In one embodiment, the foodstuff is selected from nut butters. In one embodiment, the foodstuff is peanut butter.

In respect of all emulsions it has been found that the present invention is particularly advantageous because we have further found that as well as being an effective emulsifier, the mono- or di-ester of glycerol and fatty acids has particular advantages in respect of the stability of emulsions when used as an emulsifier. The present applicants have surprisingly found that an emulsion prepared using the present mono- and di glycerides may be sufficiently stable to be used in demanding application but which is not overly stable. Thus if it is desired, the emulsion may be separated into its component phases. Separating an emulsion into its component phases may find application in many different fields and in particular in the food industry. The present invention may be used in one aspect to separate oil and water emulsions, such as water in oil emulsions, for example edible spreads. The oil phase thus separated may be reused in the production of further edible spreads. The water phase thus separated may be reliably analysed to provide information on the composition, in particular the salt content, of the initial spread.

The use of the present composition in food applications could lead to significant benefits for the customer. Such benefits would likely include; improved production yield (attributed to less down time) and allow re-work to occur more easily.

Thus in a further aspect the present invention provides use of a composition to prepare a food or feed emulsion wherein the emulsion may be separated into its constituent phases, wherein the composition comprised monoglycerides and diglycerides, wherein the monoglycerides and diglycerides have an iodine value of at least 30, and wherein the fatty acids attached to the monoglycerides and diglycerides contain C22 fatty acids in an amount of at least 4.5 wt % based on the total amount of fatty acids attached of the monoglycerides and diglycerides.

Preferred double emulsions may be selected from mayonnaise, low fat spread, peanut butter, hazelnut butter, chocolate spread, and spread containing hazelnut and cocoa.

Preferred feeds in accordance with the present invention may be selected from poultry feed, aqua culture feed, bovine feed and porcine feed. A preferred feed is a feed pellet for fish.

### Food Usage

The mono- and diglycerides (mono- and di-esters of glycerol and fatty acids) may be provided in the food or feed in the desired amount to achieve the desired function of the mono- and diglycerides.

In one embodiment, mono- and diglycerides are present in the food or feed in an amount of at least about 0.01% w/w based on the total weight of the food or feed. In one embodiment, mono- and diglycerides are present in the food or feed in an amount of at least about 0.02% w/w based on the total weight of the food or feed. In one embodiment, mono- and diglycerides are present in the food or feed in an amount of at least about 0.05% w/w based on the total weight of the food or feed. In one embodiment, mono- and diglycerides are present in the food or feed in an amount of at least about 0.1% w/w based on the total weight of the food or feed. In one embodiment, mono- and diglycerides are present in the food or feed in an amount of at least about 0.2% w/w based on the total weight of the food or feed. In one embodiment, mono- and diglycerides are present in the food or feed in an amount of at least about 0.5% w/w based on the total weight of the food or feed. In one embodiment, mono- and diglycerides are present in the food or feed in an amount of at least about 1.0% w/w based on the total weight of the food or feed. In one embodiment, mono- and diglycerides are present in the food or feed in an amount of at least about 1.2% w/w based on the total weight of the food or feed. In one embodiment, mono- and diglycerides are present in the food or feed in an amount of at least about 1.5% w/w based on the total weight of the food or feed.

In one embodiment, mono- and diglycerides are present in the food or feed in an amount of from about 0.01 to about 2.0% w/w based on the total weight of the food or feed. In one embodiment, mono- and diglycerides are present in the food or feed in an amount of from about 0.02 to about 2.0% w/w based on the total weight of the food or feed. In one embodiment, mono- and diglycerides are present in the food or feed in an amount of from about 0.05 to about 2.0% w/w based on the total weight of the food or feed. In one embodiment, mono- and diglycerides are present in the food or feed in an amount of from about 0.1 to about 2.0% w/w based on the total weight of the food or feed. In one embodiment, mono- and diglycerides are present in the food or feed in an amount of from about 0.2 to about 2.0% w/w based on the total weight of the food or feed. In one embodiment, mono- and diglycerides are present in the food or feed in an amount of from about 0.5 to about 2.0% w/w based on the total weight of the food or feed. In one embodiment, mono- and diglycerides are present in the food or feed in an amount of from about 0.5 to about 1.5% w/w based on the total weight of the food or feed. In one embodiment, mono- and diglycerides are present in the food or feed in an amount of from about 0.8 to about 1.5% w/w based on the total weight of the food or feed. In one embodiment, mono- and diglycerides are present in the food or feed in an amount of from about 1.0 to about 1.5% w/w based on the total weight of the food or feed. In one embodiment, mono- and diglycerides are present in the food or feed in an amount of from about 1.0 to about 1.2% w/w based on the total weight of the food or feed.

In one embodiment, mono- and diglycerides are present in the food or feed in an amount of at least about 1.5% w/w based on the total weight of the food or feed. In one embodiment, mono- and diglycerides are present in the food or feed in an amount of at least about 2.0% w/w based on the total weight of the food or feed. In one embodiment, mono- and diglycerides are present in the food or feed in an amount of at least about 2.2% w/w based on the total weight of the food or feed. In one embodiment, mono- and diglycerides are present in the food or feed in an amount of at least about 2.4% w/w based on the total weight of the food or feed. In one embodiment, mono- and diglycerides are present in the food or feed in an amount of at least about 2.6% w/w based on the total weight of the food or feed. In one embodiment, mono- and diglycerides are present in the food or feed in an amount of at least about 2.8% w/w based on the total weight of the food or feed. In one embodiment, mono- and diglycerides are present in the food or feed in an amount of at least about 3.0% w/w based on the total weight of the food or feed.

In one embodiment, mono- and diglycerides are present in the food or feed in an amount of at least about 1.5 to about 3.0% w/w based on the total weight of the food or feed. In one embodiment, mono- and diglycerides are present in the food or feed in an amount of at least about 2.0 to about 3.0% w/w based on the total weight of the food or feed. In one embodiment, mono- and diglycerides are present in the food or feed in an amount of at least about 2.2 to about 3.0% w/w based on the total weight of the food or feed. In one embodiment, mono- and diglycerides are present in the food or feed in an amount of at least about 2.4 to about 3.0% w/w based on the total weight of the food or feed. In one embodiment, mono- and diglycerides are present in the food or feed in an amount of at least about 2.6 to about 3.0% w/w based on the total weight of the food or feed. In one embodiment, mono- and diglycerides are present in the food or feed in an amount of at least about 2.8 to about 3.0% w/w based on the total weight of the food or feed.

In one embodiment, mono- and diglycerides are present in peanut butter in an amount of at least about 1.5% w/w based on the total weight of peanut butter. In one embodiment, mono- and diglycerides are present in peanut butter in an amount of at least about 2.0% w/w based on the total weight of peanut butter. In one embodiment, mono- and diglycerides are present in peanut butter in an amount of at least about 2.2% w/w based on the total weight of peanut butter. In one embodiment, mono- and diglycerides are present in peanut butter in an amount of at least about 2.4% w/w based on the total weight of peanut butter. In one embodiment, mono- and diglycerides are present in peanut butter in an amount of at least about 2.6% w/w based on the total weight of peanut butter. In one embodiment, mono- and diglycerides are present in peanut butter in an amount of at least about 2.8% w/w based on the total weight of peanut butter. In one embodiment, mono- and diglycerides are present in peanut butter in an amount of at least about 3.0% w/w based on the total weight of peanut butter.

In one embodiment, mono- and diglycerides are present in peanut butter in an amount of at least about 1.5 to about 3.0% w/w based on the total weight of peanut butter. In one embodiment, mono- and diglycerides are present in peanut butter in an amount of at least about 2.0 to about 3.0% w/w based on the total weight of peanut butter. In one embodiment, mono- and diglycerides are present in peanut butter in an amount of at least about 2.2 to about 3.0% w/w based on the total weight of peanut butter. In one embodiment, mono- and diglycerides are present in peanut butter in an amount of at least about 2.4 to about 3.0% w/w based on the total weight of peanut butter. In one embodiment, mono- and diglycerides are present in peanut butter in an amount of at least about 2.6 to about 3.0% w/w based on the total weight of peanut butter. In one embodiment, mono- and diglycerides are present in peanut butter in an amount of at least about 2.8 to about 3.0% w/w based on the total weight of peanut butter.

### Polyglycerol Polyricinoleic Acid (PGPR)

The composition of the present invention may be combined with polyglycerol polyricinoleic acid. Thus the present invention in a further aspect provides a composition as defined herein further comprising polyglycerol polyricinoleic acid. The present invention may further provide a food or feed comprising (i) a foodstuff; (ii) a composition comprising (a) monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides, and (b) polyglycerol polyricinoleic acid.

### Polyglycerols

Polyglycerols are substances consisting of oligomer ethers of glycerol. Polyglycerols are usually prepared from an alkaline polymerisation of glycerol at elevated temperatures.

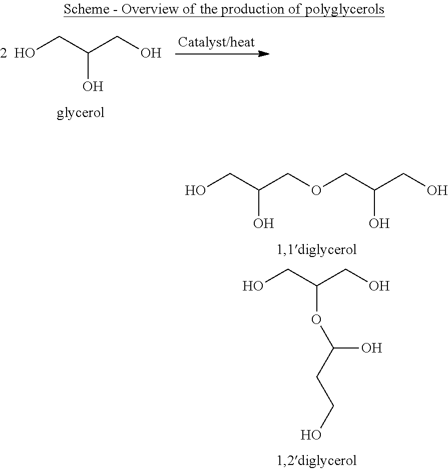

The processes for making polyglycerols are well known to the person skilled in the art and can be found, for example, in “Emulsifiers in Food Technology”, Blackwell Publishing, edited by R J Whithurst, page 110 to 130.

It will be understood that the degree of polymerisation can vary. It will be understood that polyglycerol is typically a mixture of polyglycerols of varying degrees of polymerisation. In one embodiment, the polyglycerol used to form the polyglycerol ester of a polymerised fatty acid is a mixture of polyglycerols selected from diglycerol, triglycerol, tetraglycerol, pentaglycerol, hexaglycerol, heptaglycerol, octaglycerol, nonaglycerol and decaglycerol. In one preferred embodiment triglycerol is the most abundant polyglycerol in the mixture of polyglycerols. In one preferred embodiment tetraglycerol is the most abundant polyglycerol in the mixture of polyglycerols. In one preferred embodiment the mixture of polyglycerols contains triglycerol in an amount of 30-50 wt % based on the total weight of polyglycerols and contains tetraglycerol in an amount of 10-30 wt % based on the total weight of polyglycerols.

In one embodiment, the polyglycerol is considered to be a diglycerol. In one embodiment, the polyglycerol is considered to be a triglycerol. In one embodiment, the polyglycerol is considered to be a tetraglycerol. In one embodiment, the polyglycerol is considered to be a pentaglycerol. In one embodiment, the polyglycerol is considered to be a hexaglycerol. In one embodiment, the polyglycerol is considered to be a heptaglycerol. In one embodiment, the polyglycerol is considered to be an octaglycerol. In one embodiment, the polyglycerol is considered to be a nonaglycerol. In one embodiment, the polyglycerol is considered to be a decaglycerol.

Preferably the polyglycerol is considered to be a triglycerol. Preferably the polyglycerol is considered to be a tetraglycerol.

In one embodiment, the polyglycerol moiety shall be composed of not less than 75% of di-, tri- and tetraglycerols and shall contain no more than 10% of polyglycerols equal to or higher than heptaglycerol.

Polyglycerols may be linear, branched or cyclic in structure. Typically, all three types of polyglycerol structure are present in the composition of the present invention.

### Fatty Acids

Fatty acids are well known in the art. They typically comprise an “acid moiety” and a “fatty chain”. The properties of the fatty acid can vary depending on the length of the fatty chain, its degree of saturation, and the presence of any substituents on the fatty chain. Examples of fatty acids are palmitic acid, stearic acid, oleic acid, and ricinoleic acid.

The fatty acid used according to this aspect of the present invention is ricinoleic acid.

Ricinoleic acid is a chiral molecule. Two steric representations of ricinoleic acid are given below:

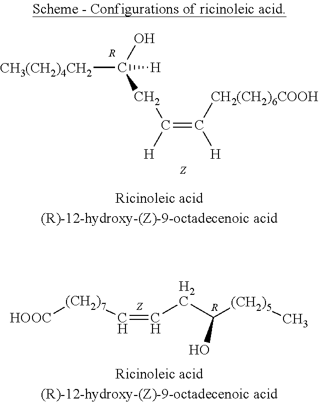

The ricinoleic acid used in the present invention may be prepared by any suitable means known to the person skilled in the art. Typically, fatty acids are produced from a parent oil via hydrolyzation and distillation.

### Crystallisation Control

As discussed herein, the present composition may be used in the control of the crystallisation of a triglyceride. Thus the present invention provides:
a process for controlling the crystallisation of a triglyceride, the process comprising the steps of (i) providing a triglyceride (ii) contacting the triglyceride with a composition comprising monoglycerides and diglycerides as described herein.
use of a composition comprising monoglycerides and diglycerides as described herein to control the crystallisation of a triglyceride.
use of a composition comprising monoglycerides and diglycerides as described herein to increase onset temperature of crystallisation of a triglyceride compared to the triglyceride in the absence of the of a composition comprising monoglycerides and diglycerides.
use of a composition comprising monoglycerides and diglycerides as described herein to increase onset temperature of crystallisation of a triglyceride compared to the triglyceride in the absence of the composition comprising monoglycerides and diglycerides as described herein.

It will be appreciated by one skilled in the art that by ‘control crystallisation’ or ‘controlling crystallisation’ it is meant that the rate or degree of crystallisation of the triglyceride can be increased or retarded. The terms ‘control crystallisation’ or ‘controlling crystallisation’ encompass increasing the rate of crystallisation, increasing the extent of crystallisation, decreasing the rate of crystallisation and decreasing the extent of crystallisation. It has been surprisingly found that the present mono- and diglycerides have particular advantages in controlling the crystallisation of triglycerides. The present applicants have surprisingly found that the present mono- and diglycerides may in some aspects be used to increase the rate of crystallisation and/or increase the extent of crystallisation of triglycerides. The present applicants have also found that the present mono- and diglycerides may in some aspects be used to decrease the rate of crystallisation and/or decrease the extent of crystallisation of triglycerides.

The present mono- and diglycerides may be contacted with the triglyceride in the desired amount to achieved the desired function of the present mono- and diglycerides, namely to control crystallisation.

In one embodiment, the present mono- and diglycerides are contacted with the triglyceride in an amount of at least about 0.01% w/w based on the total weight of the triglyceride. In one embodiment, the present mono- and diglycerides are contacted with the triglyceride in an amount of at least about 0.02% w/w based on the total weight of the triglyceride. In one embodiment, the present mono- and diglycerides are contacted with the triglyceride in an amount of at least about 0.03% w/w based on the total weight of the triglyceride. In one embodiment, the present mono- and diglycerides are contacted with the triglyceride in an amount of at least about 0.04% w/w based on the total weight of the triglyceride. In one embodiment, the present mono- and diglycerides are contacted with the triglyceride in an amount of at least about 0.05% w/w based on the total weight of the triglyceride. In one embodiment, the present mono- and diglycerides are contacted with the triglyceride in an amount of at least about 0.075% w/w based on the total weight of the triglyceride. In one embodiment, the present mono- and diglycerides are contacted with the triglyceride in an amount of at least about 0.1% w/w based on the total weight of the triglyceride. In one embodiment, the present mono- and diglycerides are contacted with the triglyceride in an amount of at least about 0.15% w/w based on the total weight of the triglyceride. In one embodiment, the present mono- and diglycerides are contacted with the triglyceride in an amount of at least about 0.2% w/w based on the total weight of the triglyceride. In one embodiment, the present mono- and diglycerides are contacted with the triglyceride in an amount of at least about 0.3% w/w based on the total weight of the triglyceride. In one embodiment, the present mono- and diglycerides are contacted with the triglyceride in an amount of at least about 0.4% w/w based on the total weight of the triglyceride. In one embodiment, the present mono- and diglycerides are contacted with the triglyceride in an amount of at least about 0.5% why based on the total weight of the triglyceride. In one embodiment, the present mono- and diglycerides are contacted with the triglyceride in an amount of at least about 1.0% w/w based on the total weight of the triglyceride. In one embodiment, the present mono- and diglycerides are contacted with the triglyceride in an amount of at least about 2.0% w/w based on the total weight of the triglyceride. In one embodiment, the present mono- and diglycerides are contacted with the triglyceride in an amount of at least about 3.0% w/w based on the total weight of the triglyceride. In one embodiment, the present mono- and diglycerides are contacted with the triglyceride in an amount of at least about 5.0% w/w based on the total weight of the triglyceride. In one embodiment, the present mono- and diglycerides are contacted with the triglyceride in an amount of at least about 10.0% w/w based on the total weight of the triglyceride.

In one embodiment, the present mono- and diglycerides are contacted with the triglyceride in an amount of from about 0.01 to about 2.0% w/w based on the total weight of the triglyceride. In one embodiment, the present mono- and diglycerides are contacted with the triglyceride in an amount of from about 0.01 to about 1.8% w/w based on the total weight of the triglyceride. In one embodiment, the present mono- and diglycerides are contacted with the triglyceride in an amount of from about 0.01 to about 1.5% w/w based on the total weight of the triglyceride. In one embodiment, the present mono- and diglycerides are contacted with the triglyceride in an amount of from about 0.05 to about 1.5% w/w based on the total weight of the triglyceride. In one embodiment, the present mono- and diglycerides are contacted with the triglyceride in an amount of from about 0.075 to about 1.5% w/w based on the total weight of the triglyceride. In one embodiment, the present mono- and diglycerides are contacted with the triglyceride in an amount of from about 0.1 to about 1.5% w/w based on the total weight of the triglyceride. In one embodiment, the present mono- and diglycerides are contacted with the triglyceride in an amount of from about 0.1 to about 1.2% w/w based on the total weight of the triglyceride. In one embodiment, the present mono- and diglycerides are contacted with the triglyceride in an amount of from about 0.1 to about 1.0% w/w based on the total weight of the triglyceride. In one embodiment, the present mono- and diglycerides are contacted with the triglyceride in an amount of from about 0.1 to about 0.8% w/w based on the total weight of the triglyceride. In one embodiment, the present mono- and diglycerides are contacted with the triglyceride in an amount of from about 0.1 to about 0.6% w/w based on the total weight of the triglyceride. In one embodiment, the present mono- and diglycerides are contacted with the triglyceride in an amount of from about 0.2 to about 0.6% w/w based on the total weight of the triglyceride. In one embodiment, the present mono- and diglycerides are contacted with the triglyceride in an amount of from about 0.3 to about 0.6% w/w based on the total weight of the triglyceride.

In one embodiment, the present mono- and diglycerides are contacted with the triglyceride in an amount of no greater than 2.0 wt % based on the triglyceride.

In one embodiment, the present mono- and diglycerides are contacted with the triglyceride in an amount of from 0.5 to 1.0 wt % based on the triglyceride.

In the process of the present invention the mono- and diglycerides may be contacted with triglyceride in any suitable means. In one aspect, the triglyceride is part of or may be incorporated into an emulsion. A suitable emulsion includes an oil in water emulsion or a water in oil emulsion. In this aspect, the mono- and diglycerides may be contacted with the triglyceride by any suitable route. It will be appreciated that in such an emulsion, the triglyceride will constitute a fat phase of the emulsion. The mono- and diglycerides may be added to one or both of the (i) fat phase; and (ii) aqueous phase prior to the contact of the (i) fat phase; and (ii) aqueous phase and thereby be present on contact of the (i) fat phase; and (ii) aqueous phase. Alternatively, the mono- and diglycerides may be added to the (i) fat phase; and (ii) aqueous phase once they have been combined or as they are combined.

The triglyceride contacted with the present mono- and diglycerides may be any suitable triglyceride. The triglyceride may be obtained from any suitable oil from a plant source, oil from an animal source or oil from a marine source. Oils from a marine source include oils from marine algae. Preferably the triglyceride is obtained from any suitable plant oil. In one preferred aspect the triglyceride is obtained from a plant selected from hard oils, soft oils and mixtures thereof and in particular is selected from palm oil, rape seed oil, sunflower oil, fish oils, soybean oils, coconut oils, rice bran oils, dag oils, beef tallow, allanblackia oils and shea fat. Preferably the triglyceride is selected from palm oil, palm stearine and palm olein.

As discussed herein, by ‘control crystallisation’ or ‘controlling crystallisation’ it is meant that the rate or degree of crystallisation of the triglyceride can be increased or retarded. In one aspect the present mono- and diglycerides increases the rate of crystallisation of a triglyceride. In one aspect the present mono- and diglycerides increases the extent of crystallisation of a triglyceride.

In one aspect the present mono- and diglycerides decrease the rate of crystallisation of a triglyceride

In one aspect the present mono- and diglycerides decrease the extent of crystallisation of a triglyceride.

In one aspect the present mono- and diglycerides increase the rate of crystallisation of a triglyceride

In one aspect the present mono- and diglycerides increase the extent of crystallisation of a triglyceride.

In one aspect the present mono- and diglycerides increase onset temperature of crystallisation of the triglyceride compared to the triglyceride in the absence of the present mono- and diglycerides. Preferably the increase of onset temperature of crystallisation is at least 1° C. Preferably the increase of onset temperature of crystallisation is at least 2° C. Preferably the increase of onset temperature of crystallisation is at least 3° C. Preferably the increase of onset temperature of crystallisation is at least 4° C.

In one aspect the present mono- and diglycerides decrease onset temperature of crystallisation of the triglyceride compared to the triglyceride in the absence of the present mono- and diglycerides. Preferably the decrease of onset temperature of crystallisation is at least 1° C. Preferably the decrease of onset temperature of crystallisation is at least 2° C. Preferably the decrease of onset temperature of crystallisation is at least 3° C. Preferably the decrease of onset temperature of crystallisation is at least 4° C.

Although the present invention primarily relates to controlling crystallisation of a triglyceride, the triglyceride may contain further materials the crystallisation of which may also be controlled by the present mono- and diglycerides. These further materials include and are preferably selected from waxes, phytosterols, stanol esters and cholesterols. It will therefore be appreciated by one skilled in the art that the present invention provides for the control of crystallisation of a triglyceride and the control of crystallisation of a material selected from waxes, phytosterols, stanol esters and cholesterols.

In some aspects the present mono- and diglycerides may be used to control crystallisation of a material selected from waxes, phytosterols, stanol esters and cholesterols independently of any control of crystallisation of a triglyceride. Thus in further broad aspects the present invention provides:
a process for controlling the crystallisation of a material selected from waxes, phytosterols, stanol esters and cholesterols, the process comprising the steps of (i) providing a material selected from waxes, phytosterols, stanol esters and cholesterols (ii) contacting the material selected from waxes, phytosterols, stanol esters and cholesterols with a composition comprising monoglycerides and diglycerides as described herein.
use of a composition comprising monoglycerides and diglycerides as described herein to control the crystallisation of a material selected from waxes, phytosterols, stanol esters and cholesterols.
use of a composition comprising monoglycerides and diglycerides as described herein to increase onset temperature of crystallisation of a material selected from waxes, phytosterols, stand esters and cholesterols compared to the material selected from waxes, phytosterols, stanol esters and cholesterols in the absence of the of a composition comprising monoglycerides and diglycerides.
use of a composition comprising monoglycerides and diglycerides as described herein to increase onset temperature of crystallisation of a material selected from waxes, phytosterols, stanol esters and cholesterols compared to the material selected from waxes, phytosterols, stanol esters and cholesterols in the absence of the composition comprising monoglycerides and diglycerides as described herein.

The material selected from waxes, phytosterols, stanol esters and cholesterols is preferably selected from bees wax, carnauba wax, vegetable waxes, rice bran wax, sunflower wax, jojoba wax, heRP70 (fatty acid composition containing 5% C16:0, 40% C18:0, 9% C20:0, and 43% C22:0, more than 99.5% of the fats of which are saturated), candelilla wax, ursolic acid, oleanolic acid, phytosterols, beta sitosterol, gamma oryzanol, cyclodextrins, sphingolipids, 12-hydroxystearic acid, ricinelaidic acid, phospholipids of lecithin, phosphatidylinositol (PI), lysophosphatidylcholine (LPC), and phosphatidylcholine (PC),

### Further Compositions

It will be appreciated by one skilled in the art that the composition of the present invention may be incorporated into further materials. However, in some aspects the present composition is to be used as an emulsifier or as a crystallisation improver without further addition. Thus in further aspects the present invention provides:
an emulsifier consisting of a composition comprising monoglycerides and diglycerides, wherein the monoglycerides and diglycerides have an iodine value of at least 30 and wherein the fatty acids attached to the monoglycerides and diglycerides contain C22 fatty acids in an amount of at least 4.5 wt % based on the total amount of fatty acids attached of the monoglycerides and diglycerides.
a crystallisation improver consisting of a composition comprising monoglycerides and diglycerides, wherein the monoglycerides and diglycerides have an iodine value of at least 30 and wherein the fatty acids attached to the monoglycerides and diglycerides contain C22 fatty acids in an amount of at least 4.5 wt % based on the total amount of fatty acids attached of the monoglycerides and diglycerides.

### BRIEF DESCRIPTION OF FIGURES

FIGS. 1 to 5 show pictures;

FIGS. 6 to 8 show graphs;

FIGS. 9 to 11 show pictures;

FIGS. 12 to 14 show graphs;

FIGS. 15 and 16 show pictures;

FIGS. 17 and 18 show graphs;

FIGS. 19 and 20 show pictures;

FIG. 21 shows a graph; and

FIGS. 22 and 23 show pictures.

### EXAMPLES

The present invention will now be defined with reference to the following non-limiting examples.

### Materials & Methods

Three samples of mono and diglycerides were prepared by blending of commercial mono and diglycerides. Table 1 shows the composition (with the exception of the fatty acid composition)

TABLE 1
Showing the novel mono and diglycerides with
breakdown of mono, di-, and tri- glycerides.

| | SM90 | SM60 | SM80 |
|---|---|---|---|
| GL | 0.16 | 0.24 | 0.20 |
| Digl | 0.14 | 0.1 | 0.18 |
| FFA | 0.30 | 0.40 | 0.40 |
| Mono | 96.50 | 64.56 | 82.87 |
| Di | 2.64 | 29.02 | 15.28 |
| Tri | 0.22 | 2.59 | 1.10 |

In Table 1, the abbreviations stand for
GL—Glycerol, Digl—Diglycerol, FFA—Free Fatty Acids, Mono—Monoglycerides, Di—Diglycerides, and Tri—Triglycerides.

The detail of the fatty acid composition of the novel mono and diglycerides is shown in Table 2.

TABLE 2
Fatty acid composition of SM 90, SM60, and SM80

| | E100553-1 | E100553-2 | E100553-3 |
|---|---|---|---|
| | (SM 90) | (SM 60) | (SM 80) |
| C₁₀ | <0.1 | 0.0 | 0.0 |
| C₁₂ | 0.1 | 0.1 | 0.1 |
| C₁₄ | 0.1 | 0.5 | 0.3 |
| C₁₅ | <0.1 | <0.1 | 0.1 |
| C₁₆ | 5.3 | 21.5 | 12.7 |
| C_{16:1} | 0.1 | 0.1 | 0.2 |
| C₁₇ | 0.1 | 0.1 | 0.1 |
| C₁₈ | 10.9 | 4.1 | 7.8 |
| C_{18:1} | 64.6 | 23.9 | 47.6 |
| C_{18:2} | 5.2 | 10.8 | 7.7 |
| C_{18:3} | 0.0 | 3.8 | 2.0 |
| C₂₀ | 1.3 | 1.0 | 1.0 |
| C_{20:1} | 1.4 | 2.6 | 1.8 |
| C_{20:unsaturated} | 0.1 | 0.9 | 0.7 |
| C₂₂ | 10.7 | 8.8 | 7.2 |
| C_{22:1} | 0.0 | 20.7 | 10.0 |
| C_{22:unsaturated} | 0.0 | 0.8 | 0.4 |
| C₂₄ | 0.3 | 0.3 | 0.3 |
| C_{24:1} | 0.0 | 0.4 | 0.2 |

The iodine values (IV) of these samples was calculated according to the principles reported by Kyriakidis, and Katiloulis (2000) as:

| | |
|---|---|
| SM 90 IV total: 66 | (Sat 28.8 Mono unsat 66.1 Poly unsat 5.3) |
| SM 60 IV total: 70 | (Sat 36.4 Mono unsat 47.3 Poly unsat 16.3) |
| SM 80 IV total: 71 | (Sat 29.5 Mono unsat 66.1 Poly unsat 5.3) |

TABLE 3
Fatty acid composition of GRINDSTED ® CRYSTALLIZER 110

| Fatty acid | |
|---|---|
| chain length | % present |
| C₁₈ | 2.0 |
| C₂₀ | 5.0 |
| C₂₂ | 89.0 |
| C_{22:1} | 0.2 |
| C₂₄ | 3.0 |

Regarding the fatty acid composition from a saturated/unsaturated aspect, Table 4 gives the total distribution.

TABLE 4
Total distribution of saturated, unsaturated fatty acids
and actual total saturated chain length from C20:0

| Distribution of SAT/ | | | |
|---|---|---|---|
| un-SAT chain length | SM90 | SM60 | SM80 |
| Saturated | 28.6 | 36.3 | 29.4 |
| Unsaturated | 71.4 | 63.6 | 70.6 |
| Total | 100 ± 0.1 | 100 ± 0.1 | 100 ± 0.1 |
| SATs from C20:0> | 12.3 | 10.1 | 8.5 |

### Water Droplet Size

Water droplet analysis was carried out using a Bruker Minispec NMS 120 (20 MHz) according to the standard method:

Pulsed NMR analysis using a pulsed gradient unit Bruker Minispec mq 20, 20 MHz low field pulsed pNMR Analyzer, Magnet unit ND2172, equipped with a Pulsed Gradient Unit 1059. High/low temperature probehead assembly mq-PA231 (−120° C.-+200° C.). Software: SSL, system status logging. CONTIN transformation. Pulsed gradient system for 10 mm tubes (10×180×0.6 mm=diameter×length×thickness). Mq-SOFT EDMs Oil droplets/Water droplets and Diffusio. Bruker gas tempering unit for high and low temperature analysis: mq-BVT3000c (for minispec probe PA231). Measurements are performed at 20° C. and field gradients of 2.0 T/m or higher.

### Analytical Principle:

A Hahn spin echo experiment with field gradient pulses involves calculating the reduction in spin echo amplitude compared with the Hahn spin echo amplitude without field gradient pulses (R).

Determining diffusion coefficient of water molecules If protons can move unhindered in the liquid, then free diffusion is taking place, and the diffusion coefficient D can be determined directly from R.

Determining droplet size distribution in w/o emulsions If proton movement is restricted by the boundaries of a droplet, an R value plateau is obtained reflecting the droplet size. When measuring at several pulse lengths, the corresponding R plateau values give a fingerprint of the droplet size distribution. Measurements are performed at 5° C. and with 8 R values. Log-normal particle size distribution is typically seen in w/o emulsions and is used in the mathematical calculation of droplet size distribution. Results are given as volume and number size distribution

2.5% of droplet volume is smaller than “x” μm
50% of droplet volume is smaller than “x” μm.
97.5% of droplet volume is smaller than “x” μm.
and derived from a log-scale using values of the following standardized normal distribution

$$\begin{matrix}2.5 \% < μ \\ ( {d}_{lower} )\end{matrix} \begin{matrix}\begin{matrix}50 \% < μ \\ ( {d}_{50 , 3} )\end{matrix} & \begin{matrix}97.5 \% < μ \\ ( {d}_{upper} )\end{matrix}\end{matrix}$$

### Polarised Light Microscopy

This technique is useful in highlighting the conformational changes that take place within a fat-based system under thermal manipulation—in this case cooling. The technique is described briefly:

Several analyses of W/O emulsions and continuous bulk oil phase systems were observed using an Olympus BX60 optical microscope (Serial no: 6M02546), fitted with polarized filter (Olympus Optical Co. GmbH. Hamburg, Germany). The desired amount of sample (˜40 mg) is placed on a carrier glass slide which has been pre-cooled or preheated to ˜5° C. A cover slip was than placed parallel to the plane of the carrier slide and centred on the drop of sample to ensure uniformity and desirability of sample thickness. The micrograph of the crystal was taken at 40× and 200× magnification unless otherwise indicated. A number of images were acquired each representing a typical field.

### Induction Heat/Cool/Micrograph Images:

Micrograph images were collected in polarised light using a Evolution Color-camera (MP 5.0 RTV 32-0041C-309) supplied from Media Cybernetics (Media Cybernetics, Inc. USA.) attached to the Olympus BX60 optical microscope with following parameters: Heat step 50° C./minute to 80° C., tempering for 2 minutes. Then cool 1° C./minute-10° C./minute-50° C./minute and 100° C./minute to 20° C.

1° C./minute every 30 seconds.
10° C./minute every 10 seconds.
50° C./minute every 3 seconds.
100° C./minute every 3 seconds.

More images were collected at 100° C./min to 20° C., using longer induction time whereby images were taken every 30 seconds for 5 minutes.

### Rheology

The rheology was run such that:

Each sample was then pre-heated in a microwave oven for 2 minutes at maximum power before testing, such that the temperature exceeded 90° C. in order to destroy any crystal history before the sample was then cooled on the rheometer. In each case the measurements were carried out using a controlled stress Haake RS 150 rheometer fitted with a serrated parallel plate of 35 mm in diameter, both top and bottom. Cooling took place from 85° C. to 25° C. at the rate of 1° C. per minute. The strain used was 0.004, 120 data points were collected, the frequency was fixed at 0.5 Hz, and the gap was reduced to 0.5 mm.

Or alternatively the following method was used:

Investigation of bulk oil blends subjected to the effects of controlled cooling rate while under shear were analysed using a shear stress controlled rotational rheometer Rheometrics SR 5 (proRheo, Germany) controlled stress rheometer operating in simulated rate control mode. Target shear rate of 10 s-1. Crystal history was removed through melting and holding to 90° C. for 15 minutes before loading onto the rheometer. A thermoelectric cooling plate using Peltier effect cooling, with parallel plate geometry (40 mm diameter top plate. Gap=1 mm) and a temperature ramp 70° C. to 25° C. at either 1° C./min, 10° C./min, 30° C./min, was used. A2 minute delay without shear at 70° C. prior to thermo-cooling was also used.

### Interfacial Tensiometry

Interfacial tensiometry described as follows:

The interfacial tension of oil/water systems was measured on a Digital-Tensiometer, model K10ST (Krüss Germany), using the Wilhelmy plate method, and recorded continuously by connecting a high resolution data recorder (PicoLog ADC-20, using PicoLog for windows 5.13.4 from Pico Technology Ltd, Cambridgeshire. United Kingdom) connected to the tensiometer. A second channel on the recorder was used to monitor the temperature of the oil/water system in the tensiometer. The oil/water phase was controlled by a programmable water bath (model: Thermo Haake® DC10-K10, refrigerated circulator. Sigma-Aldrich, Denmark A/S. Copenhagen, Denmark), which allowed the temperature to be changed from 50° C. to 5° C. Prior to initializing measurement the tensiometer K10ST was calibrated for the oil phase to show more than 27 mN/m at 20° C. and held constant for 15 min, enabling both oil and instrument to reach equilibrium constant.

Measurements were started at 50° C. after preheating the oil phase and the water phase to 50° C. separately. Prior to commencing with a temperature sweep, the interfacial tension was measured at 50° C. for 5 minutes to whereby a state of equilibrium between the oil and water phases is thought to be obtained. Then the temperature was decreased to 5° C. at 0.3° C./min and kept at 5° C. for 5 minutes.

Preparation of the solvent and the actual samples for interfacial tensiometry measurements were carried out as follows:

### Solvent:

Refined, bleached and deodorized sunflower oil, iodine value 127, was obtained from AAK (Aarhus, Denmark). Purification was then carried out using the following procedure: Mix 30 g of Fluorisil PR60/100 mesh (Sigma-Aldrich Denmark A/S) with 500 g Sunflower Oil in a vessel. The mixture was stirred for 60 min at 80° C., and protected from UV light. After cooling over 12 hrs, the sunflower oil was passed slowly at room temperature through a glass column with filter paper (glass fiber GA55, 47 mm) into 800 ml UV light protected beaker. This procedure results in the sunflower oil having an interfacial tension at 20° C. of 28-30 mN/m (oil-water)

### Preparation of Samples

Oil phase: Emulsifiers were weighed for tensiometer measurements at 0.02% w/w (unless otherwise indicated) and the RBD sunflower oil balanced to 100%. The preparation is heated to 10° C. above melting point of emulsifier, and held for 1 hour, then cooled to ambient temperature and deaerated (˜12 hrs). Water phase: Demineralised water is deaerated using a Desiccator (Sigma-Aldrich, Denmark NS. Copenhagen, Denmark). Both phases are ready to use after heating to 50° C.

### Fat Blends and Recipes Used

A fat blend of 70% Palm Stearine of IV 48 and 30% of Palm Olein of IV 56 was used, to which was added 1% of GRINDSTED® CRYSTALLIZER 110 or 0.5% GRINDSTED® PGPR 90.

Two fat concentrations were studied, 35% and 40%, both of which still fall within the low fat spread constraints. The recipes of the spreads are given in Tables 5 and 6. In the case of the 35% fat samples (Table 5) the water phase is empty, i.e. does not contain hydrocolloid thickeners, whereas in the case of 40% fat spreads (Table 6) the water phase contains GRINDSTED® LFS 560 Stabiliser System. The plant process conditions are subsequently given for the 35% and 40% fat samples in Table 7, and were the same in each case.

The procedure for this process is given as:

TABLE 5
Recipe and for low fat spread samples
with GRINDSTED ® CRYSTALLIZER
110 at 35% fat content.

| | | | | |
|---|---|---|---|---|
| Ingredient Name | 21 | 23 | 24 | 25 |

Ingredients in %
Water phase

| | | | | |
|---|---|---|---|---|
| Water (Tap) | 64.000 | 64.000 | 64.000 | 64.000 |
| Salt (Sodium Chloride) | 1.000 | 1.000 | 1.000 | 1.000 |
| Butter Flavouring | 0.010 | 0.010 | 0.010 | 0.010 |
| 050001 T03007 | | | | |
| Water phase total | 65.010 | 65.010 | 65.010 | 65.010 |
| pH | 5.5 | 5.5 | 5.5 | 5.5 |

Fat phase
Fat blend

| | | | | |
|---|---|---|---|---|
| PK4 - INES | 25.000 | 25.000 | 25.000 | 25.000 |
| COLZAO | 75.000 | 75.000 | 75.000 | 75.000 |
| Fat blend total | 100.000 | 100.000 | 100.000 | 100.000 |

Other fat ingredients

| | | | | |
|---|---|---|---|---|
| GRINDSTED ® | 0.150 | 0.300 | 0.600 | 1.200 |
| CRYSTALLIZER 110 - K. | | | | |
| Distilled Monoglyceride | | | | |
| 2% sol. beta-carotene | 0.020 | 0.020 | 0.020 | 0.020 |
| Butter Flavouring | 0.020 | 0.020 | 0.020 | 0.020 |
| 050001 T04184 | | | | |
| Other fat | 0.190 | 0.340 | 0.640 | 1.240 |
| ingredients total | | | | |
| Fat phase total | 34.990 | 34.990 | 34.990 | 34.990 |
| RECIPE total | 100.000 | 100.000 | 100.000 | 100.000 |
| (calc. batchsize) | | | | |

PK4 - INES is an interesterified oil made from, palm stearin and palm kernel oil COLZAO is rapeseed oil

TABLE 6
Recipe and for low fat spread samples
with GRINDSTED ® CRYSTALLIZER
110 at 40% fat content.

| | | | | |
|---|---|---|---|---|
| Ingredient Name | 12 | 13 | 14 | 15 |

Ingredients in %
Water phase

| | | | | |
|---|---|---|---|---|
| Water (Tap) | 57.300 | 57.300 | 57.300 | 57.300 |
| Salt (Sodium Chloride) | 1.000 | 1.000 | 1.000 | 1.000 |
| Skimmed milk powder | 0.100 | 0.100 | 0.100 | 0.100 |
| (MILEX 240) | | | | |
| GRINDSTED ® LFS 560 | 1.500 | 1.500 | 1.500 | 1.500 |
| Stabiliser System | | | | |
| Potassium Sorbate | 0.100 | 0.100 | 0.100 | 0.100 |
| Butter Flavouring | 0.010 | 0.010 | 0.010 | 0.010 |
| 050001 T03007 | | | | |
| Water phase total | 60.010 | 60.010 | 60.010 | 60.010 |
| Ph | 5.5 | 5.5 | 5.5 | 5.5 |

Fat phase
Fat blend

| | | | | |
|---|---|---|---|---|
| PK4 - INES | 25.000 | 25.000 | 25.000 | 25.000 |
| COLZAO | 75.000 | 75.000 | 75.000 | 75.000 |
| Fat blend total | 100.000 | 100.000 | 100.000 | 100.000 |

Other fat ingredients

| | | | | |
|---|---|---|---|---|
| GRINDSTED ® | 0.150 | 0.300 | 0.600 | 1.200 |
| CRYSTALLIZER 110 - K. | | | | |
| Distilled Monoglyceride | | | | |
| 2% sol. beta-carotene | 0.020 | 0.020 | 0.020 | 0.020 |
| Butter Flavouring | 0.020 | 0.020 | 0.020 | 0.020 |
| 050001 T04184 | | | | |
| Other fat | 0.190 | 0.340 | 0.640 | 1.240 |
| ingredients total | | | | |
| Fat phase total | 39.990 | 39.990 | 39.990 | 39.990 |
| RECIPE total | 100.000 | 100.000 | 100.000 | 100.000 |
| (calc. batchsize) | | | | |

TABLE 7
Pilot plant processing conditions for the recipe samples
given in Tables 5 and 6

| Processing (3-tube lab perfector): | |
|---|---|
| Oil phase temperature | 50 |
| Water phase temperature | 50 |
| Emulsion temperature | 50 |
| Centrifugal pump | Auto |
| Capacity high pressure pump | 40 |
| Cooling (NH3) tube 1: | −10 |
| Cooling (NH3) tube 2: | −10 |
| Cooling (NH3) tube 3: | −10 |
| Rpm tube 1: | 1000 |
| Rpm tube 2: | 1000 |
| Rpm tube 3: | 1000 |

Water phase:

1. Heat water to 80° C.
2. Mix all dry ingredients
3. Slowly add dry ingredients to the water stirring intensively on stirring device for 4 minutes.
4. Cool water phase to 40° C.
5. Re-weigh and add water equivalent to the amount of evaporation
6. Adjust pH with citric acid or NaOH
7. Add flavour just before running the Perfector

Fat phase:

1. Weigh out emulsifier, beta carotene (2% solution) and oil/fat in the same container

### 2. Heat to 80° C.

3. Stir the fat phase until mixed well
4. Cool the fat phase to 40° C.
5. Add flavour just before running the Perfector

Emulsion:

Add the water phase to the fat phase while stirring intensively

Tables 8 and 9 give the recipes for the trials featuring the evaluation of the novel mono and diglycerides in low fat W/O emulsions. The procedure and pilot plant conditions for these recipes are identical with those featured above and in Table 7.

TABLE 8
Recipe for low fat spread samples with SM 90, and SM60

| | | | | | | | | |
|---|---|---|---|---|---|---|---|---|
| Ingredient Name | 31 | 32 | 33 | 34 | 35 | 36 | 37 | 38 |

Ingredients in %
Water phase

| | | | | | | | | |
|---|---|---|---|---|---|---|---|---|
| Water (Tap) | 57.300 | 57.300 | 57.300 | 57.300 | 57.300 | 57.300 | 57.300 | 57.300 |
| Salt (Sodium Chloride) | 1.000 | 1.000 | 1.000 | 1.000 | 1.000 | 1.000 | 1.000 | 1.000 |
| Skimmed milk powder | 0.100 | 0.100 | 0.100 | 0.100 | 0.100 | 0.100 | 0.100 | 0.100 |
| (MILEX 240) | | | | | | | | |
| GRINDSTED ® LFS 560 | 1.500 | 1.500 | 1.500 | 1.500 | 1.500 | 1.500 | 1.500 | 1.500 |
| Stabiliser System | | | | | | | | |
| Potassium Sorbate | 0.100 | 0.100 | 0.100 | 0.100 | 0.100 | 0.100 | 0.100 | 0.100 |
| Butter Flavouring | 0.010 | 0.010 | 0.010 | 0.010 | 0.010 | 0.010 | 0.010 | 0.010 |
| 507104 A | | | | | | | | |
| Water phase total | 60.010 | 60.010 | 60.010 | 60.010 | 60.010 | 60.010 | 60.010 | 60.010 |
| pH | 5.5 | 5.5 | 5.5 | 5.5 | 5.5 | 5.5 | 5.5 | 5.5 |

Fat phase
Fat blend

| | | | | | | | | |
|---|---|---|---|---|---|---|---|---|
| PK4 - INES | 25.000 | 25.000 | 25.000 | 25.000 | 25.000 | 25.000 | 25.000 | 25.000 |
| COLZAO (Rapeseed Oil) | 75.000 | 75.000 | 75.000 | 75.000 | 75.000 | 75.000 | 75.000 | 75.000 |
| Fat blend total | 100.000 | 100.000 | 100.000 | 100.000 | 100.000 | 100.000 | 100.000 | 100.000 |

Other fat ingredients

| | | | | | | | | |
|---|---|---|---|---|---|---|---|---|
| SM90 | 0.150 | 0.300 | 0.600 | 1.200 | | | | |
| SM60 | | | | | 0.150 | 0.300 | 0.600 | 1.200 |
| 2% sol. beta-carotene | 0.020 | 0.020 | 0.020 | 0.020 | 0.020 | 0.020 | 0.020 | 0.020 |
| Butter Flavouring | 0.020 | 0.020 | 0.020 | 0.020 | 0.020 | 0.020 | 0.020 | 0.020 |
| 050001 T04184 | | | | | | | | |
| Other fat | 0.190 | 0.340 | 0.640 | 1.240 | 0.190 | 0.340 | 0.640 | 1.240 |
| ingredients total | | | | | | | | |
| Fat phase total | 39.990 | 39.990 | 39.990 | 39.990 | 39.990 | 39.990 | 39.990 | 39.990 |
| RECIPE total | 100.000 | 100.000 | 100.000 | 100.000 | 100.000 | 100.000 | 100.000 | 100.000 |
| (calc. batchsize) | | | | | | | | |

TABLE 9
Recipe for low fat spread samples with SM 80
Ingredients in %

| | | | | |
|---|---|---|---|---|
| Ingredient Name | 49 | 51 | 52 | 53 |

Water phase

| | | | | |
|---|---|---|---|---|
| Water (Tap) | 57.300 | 57.300 | 57.300 | 57.300 |
| Salt (Sodium Chloride) | 1.000 | 1.000 | 1.000 | 1.000 |
| Skimmed milk powder | 0.100 | 0.100 | 0.100 | 0.100 |
| (MILEX 240) | | | | |
| GRINDSTED ® LFS | 1.500 | 1.500 | 1.500 | 1.500 |
| 560 Stabiliser System | | | | |
| Potassium Sorbate | 0.100 | 0.100 | 0.100 | 0.100 |
| Butter Flavouring 050001 T03007 | 0.010 | 0.010 | 0.010 | 0.010 |
| Water phase total | 60.010 | 60.010 | 60.010 | 60.010 |
| pH | 5.5 | 5.5 | 5.5 | 5.5 |

Fat phase
Fat blend

| | | | | |
|---|---|---|---|---|
| PK4-INES | 25.000 | 25.000 | 25.000 | 25.000 |
| COLZAO (Rapeseed Oil) | 75.000 | 75.000 | 75.000 | 75.000 |
| Fat blend total | 100.000 | 100.000 | 100.000 | 100.000 |

Other fat ingredients

| | | | | |
|---|---|---|---|---|
| SM80 | 0.150 | 0.300 | 0.600 | 1.200 |
| 2% sol. beta-carotene | 0.020 | 0.020 | 0.020 | 0.020 |
| Butter Flavouring 050001 T04184 | 0.020 | 0.020 | 0.020 | 0.020 |
| Other fat ingredients total | 0.190 | 0.340 | 0.640 | 1.240 |
| Fat phase total | 39.990 | 39.990 | 39.990 | 39.990 |
| RECIPE total (calc. batchsize) | 100.000 | 100.000 | 100.000 | 100.000 |

### Results & Discussion

### Polarised Light Microscopy

Probing the structure of the fat blends which contain GRINDSTED® CRYSTALLIZER 110 and GRINDSTED® PGPR 90 under thermal manipulation, in this case cooling, shows the effects cooling has on the nature of the fat crystallisation kinetics. To investigate this, model systems were made using a 70/30% mixture of Palm Stearine and Palm Olein as a carrier system.

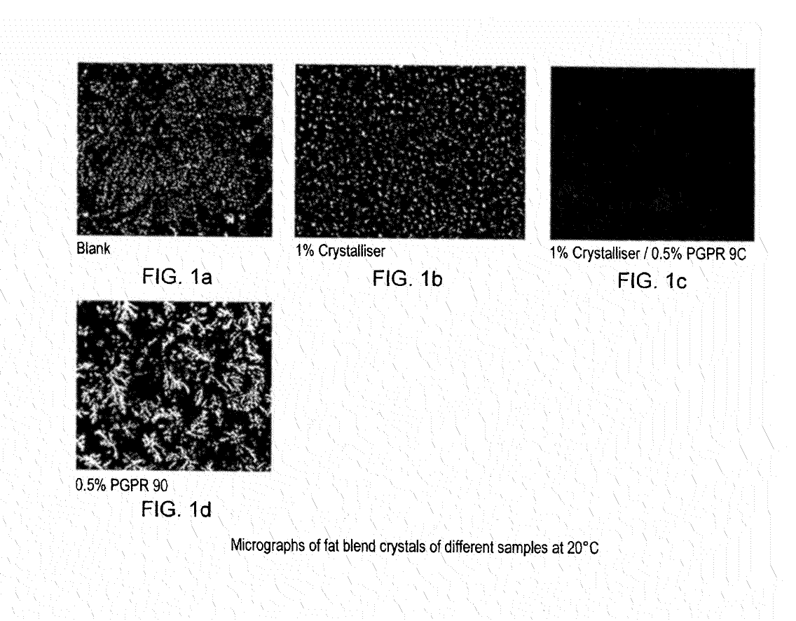

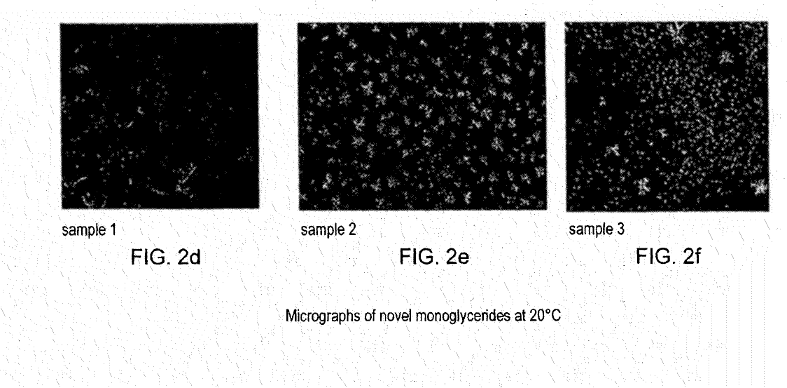

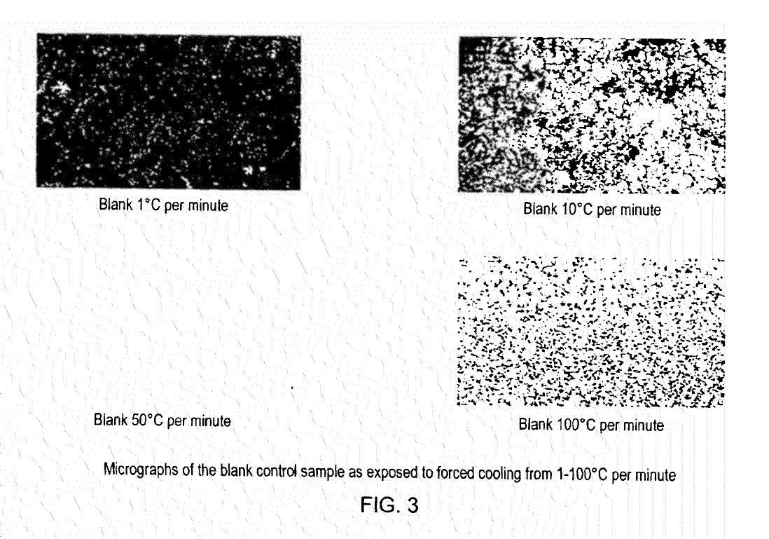

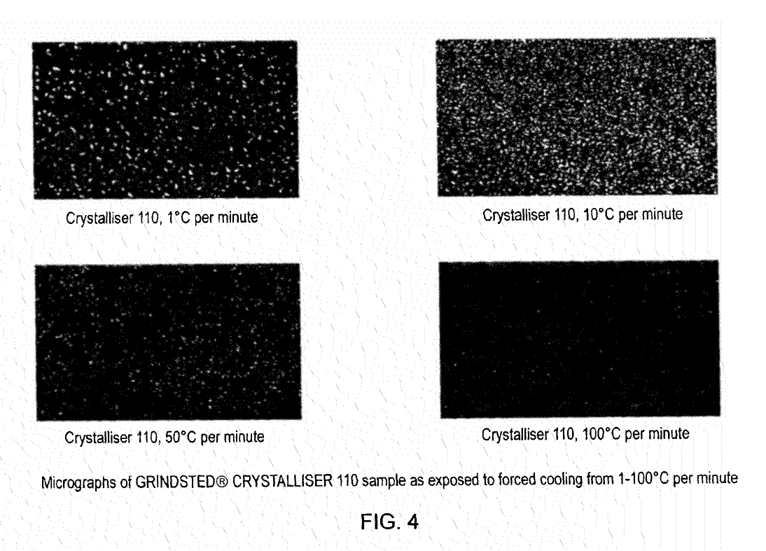

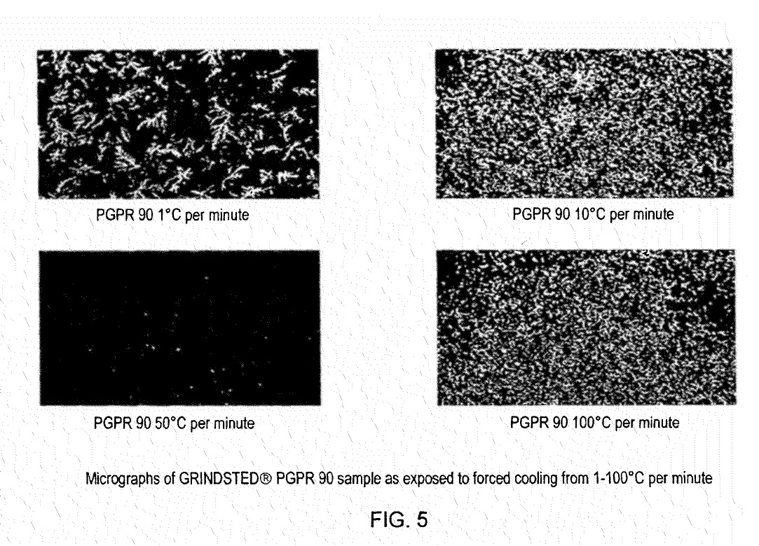

The results are given in FIGS. 1 and 2 where the end point picture at 20° C. is shown after a period of cooling from 80° C. at a rate of 1° C. per minute.

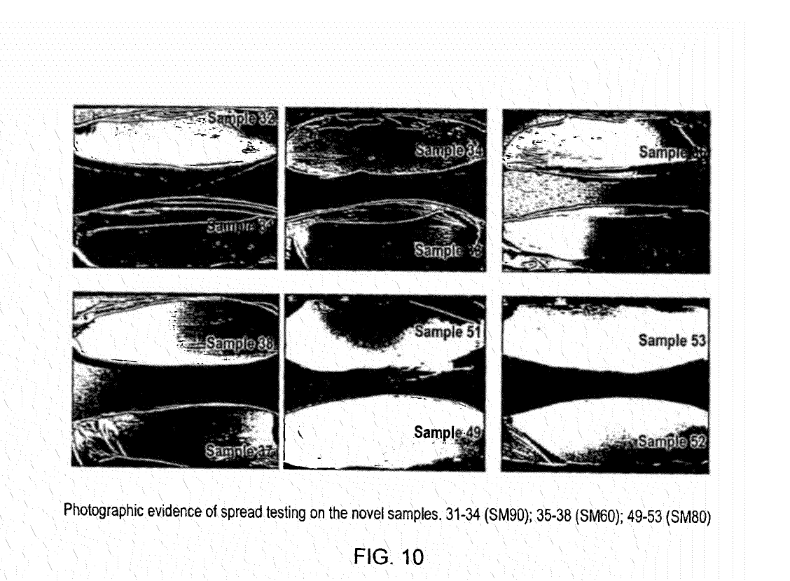

FIG. 1a shows the fat crystal build up of the control sample, where only the fat blend is present. FIG. 1b has the fat blend and GRINDSTED® CRSYTALLIZER 110 present, and small discrete fat crystal packets can be seen. At the magnification recorded these are unlikely to be individual fat crystals but rather pockets of crystallisation. FIG. 1d shows the image of the fat blend with GRINDSTED® PGPR 90 alone, and the clear formation of fern-like structures, which in essence could easily be referred to as crystalline dendritic structures as noted by Mullin (1993). Evident from FIG. 10 GRINDSTED® PGPR 90 appears to interact with GRINDSTED® CRYSTALLIZER 110 in a similar fashion creating fat crystal structures reminiscent of each other. In FIG. 2, the aim was to examine resultant polarised micrograph images for the samples. These were samples:

Sample 1 (SM 90) Mono content 96.50
Sample 2 (SM 60) Mono content 64.55
Sample 3 (SM 80) Mono content 82.87

The novel mono and diglycerides are given in FIGS. 2d to e.

Having now established that GRIDNSTED® PGPR 90 and the present mono and diglycerides are clearly forming similar crystal structures a further aspect of the model system investigation was required. Up until now, all cooling had been done either at 1° C. per minute or slower, at 0.3° C. per minute. In order to probe the effects being observed and to be able to comment on the prospect of any crystal structure benefit being transferred into final application, forced cooling on the model systems was investigated where cooling as undertaken at 1° C., 10° C., 50° C. and 100° C. per minute. The purpose of carrying out these experiments was to gain data as close as possible to the cooling rates that may occur in typical plant process environments, where conservative estimates led us to suggested cooling rates of between 35° C. and 45° C. per minute when averaged over the entire plant.

### Application Trials in Low Fat W/O Emulsion Systems

The quota of evidence linking the broad functionality of GRINDSTED® PGPR 90 and GRINDSTED® CRYSTALLIZER 110 in model systems together presented above now has to be tested in real application systems.

Exploring the first aspect of this comparative triad is the test of GRINDSTED® CRYSTALLIZER 110. Table 10 gives the water droplet size distribution results for samples of 40% and 35% low fat W/O spreads

TABLE 10
Water droplet size distribution for
40% fat spreads - samples 21, 23-25
35% fat spreads - samples 12-14
each containing GRINDSTED ® CRYSTALLZER 110.

| | Average/ | 2_5% < | 50% < | 97_5% < |
|---|---|---|---|---|
| Sample ID | St. dev. | μm | μm | μm |
| DK17124-1-11 | Average | 1.08 | 5.38 | 26.80 |
| | St. dev. | 0.02 | 0.07 | 0.54 |
| DK17124-1-12 | Average | 1.10 | 5.62 | 28.80 |
| | St. dev. | 0.05 | 0.03 | 1.14 |
| DK17124-1-13 | Average | 0.84 | 6.50 | 50.41 |
| | St. dev. | 0.04 | 0.13 | 2.75 |
| DK17124-1-14 | Average | 0.60 | 10.14 | 171.08 |
| | St. dev. | 0.04 | 0.20 | 17.17 |
| DK17124-1-16 | Average | 2.01 | 3.64 | 6.58 |
| | St. dev. | 0.09 | 0.02 | 0.36 |
| DK17124-1-21 | Average | 0.23 | 3.46 | 51.73 |
| | St. dev. | 0.01 | 0.07 | 5.26 |
| DK17124-1-22 | Average | 0.58 | 3.81 | 24.82 |
| | St. dev. | 0.03 | 0.06 | 1.16 |
| DK17124-1-23 | Average | 0.91 | 10.20 | 115.23 |
| | St. dev. | 0.05 | 0.75 | 21.16 |
| DK17124-1-24 | Average | 1.01 | 21.66 | 481.56 |
| | St. dev. | 0.05 | 3.66 | 196.53 |
| DK17124-1-25 | Average | 0.85 | 23.01 | 665.20 |
| | St. dev. | 0.13 | 4.21 | 346.97 |
| DK17124-1-26 | Average | 3.48 | 3.48 | 3.49 |
| | St. dev. | 0.01 | 0.01 | 0.01 |

The results presented in Table 10 show the water droplet size distribution for the 35% fat spreads (samples 21-26) and the 40% fat spreads (samples 11-16). It should be noted that sample DK17124-1-15 could not be measured due to the signal being too weak. Samples DK 17124-1-21, 22, 23, 24, and 26 covering the 35% fat spreads were basically phase separated, with pure liquid in the bottom of the container. Hence, this observation alone indicates that the systems were not stable, but also has a large bearing on the water droplet size results themselves. Thus, the results shown in the table are therefore not an accurate representation of the samples, and can only be treated as an average apparent value on the system. It is also worth stating here that the 35% spreads were made with an empty water phase, i.e. no stabiliser, and therefore these samples represent a spread that has really been stressed. The clear conclusion that is drawn from the results given in Table 19 is that the size of the water droplets for all samples containing GRINDSTED® CRYSTALLIZER 110 are large and therefore the spread samples are prone to instability, and hence separation. This was true irrespective of fat content either 35% or 40%, although the samples at 40% were markedly better.

Whilst the water droplet size analysis is an important tool in predicting the likely stability of low fat spreads, photographic images can also graphically highlight the structure and stability of such spreads. The images shown here demonstrate the relative ease of breakdown in the samples containing only GRINDSTED® CRYSTALLIZER 110, which were seen to be stable here.

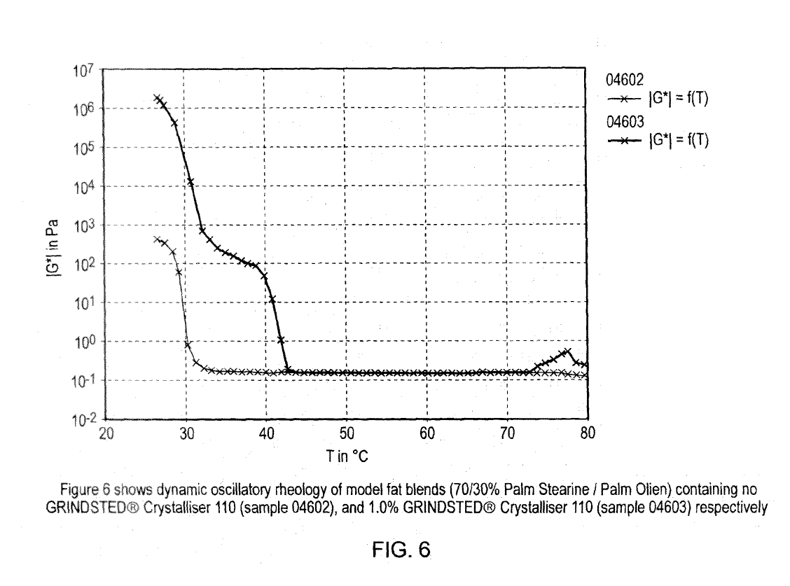

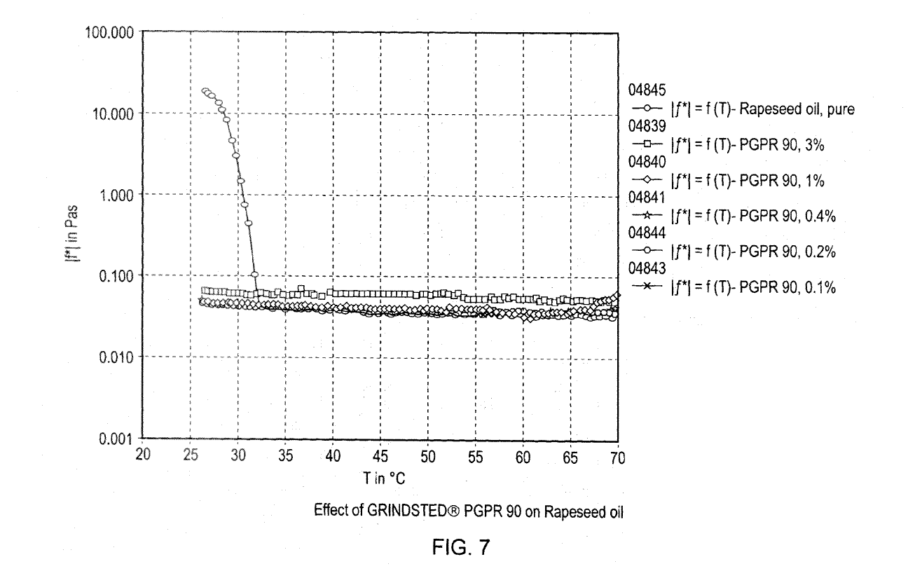

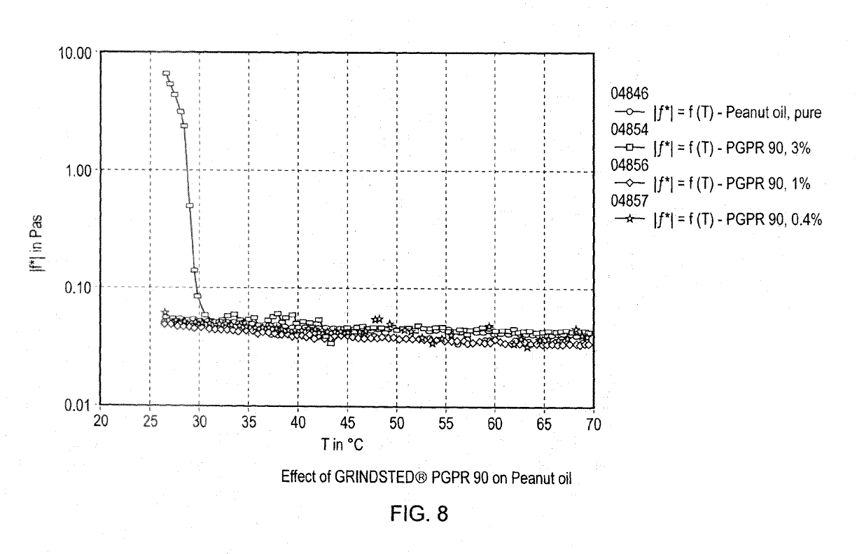

In FIGS. 6a to 6c the spread test on cardboard is seen for the samples at 40% fat content with a stabilised water phase. Samples 12-15 all contained GRINDSTED® CRYSTALLIZER 110 at increasing concentrations from 0.15, 0.3, 0.6 and 1.2% respectively and showed decreasing stability across the concentration gradient. This manifested itself as increasing water release and lumpy structure, until sample 15 was reached which was described as inverted and essentially a flipped O/W emulsion.

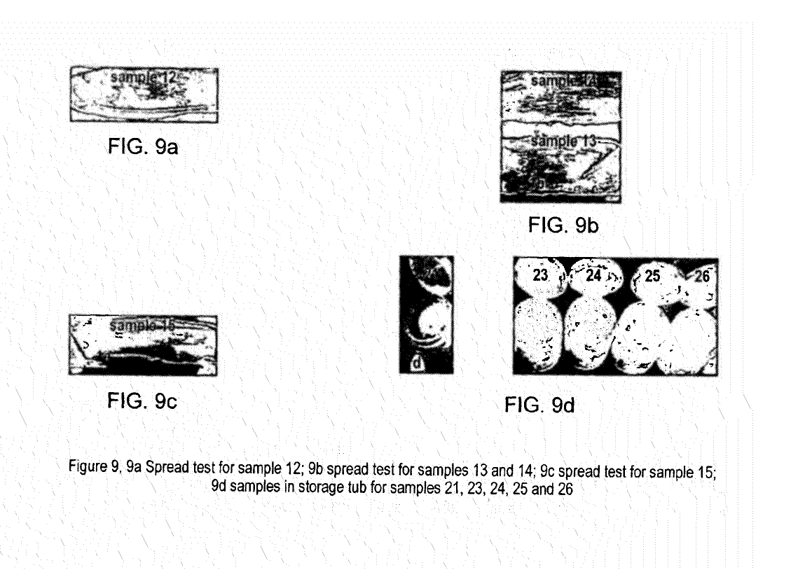

FIG. 9d shows the samples of the empty water phase at 35% fat content, where all samples are showing signs of breakdown.

In summary, the results show that low fat spreads cannot be adequately stabilised by GRINDSTED® CRYSTALLIZER 110 alone in either full or empty water phase regimes at 40% or 35% fat content. In each case there is water leakage resulting in breakdown of the emulsion or indeed full scale failure of the emulsion.

Table 11 gives the water droplet size distribution for 40% low fat spread applications made with the three novel mono- and diglycerides; SM90, SM60 and SM80.

TABLE 11
Water droplet size distribution data for novel mono- and diglycerides
SM90 (31-34), SM60 (35-38), and SM80 (49-53).

| | Average/ | 2_5% < | 50% < | 97_5% < |
|---|---|---|---|---|
| Sample ID | St. dev. | μm | μm | μm |
| DK17124-1-31 | Average | 1.33 | 5.19 | 20.22 |
| | St. dev. | 0.03 | 0.07 | 0.94 |
| DK17124-1-32 | Average | 1.31 | 4.39 | 14.70 |
| | St. dev. | 0.05 | 0.02 | 0.60 |
| DM17124-1-33 | Average | 1.38 | 3.95 | 11.34 |
| | St. dev. | 0.08 | 0.04 | 0.81 |
| DK17124-1-34 | Average | 1.33 | 3.73 | 10.56 |
| | St. dev. | 0.15 | 0.03 | 1.22 |
| DK17124-1-35 | Average | 1.61 | 6.32 | 24.75 |
| | St. dev. | 0.02 | 0.04 | 0.45 |
| DK17124-1-36 | Average | 1.48 | 5.52 | 20.51 |
| | St. dev. | 0.04 | 0.05 | 0.72 |
| DK17124-1-37 | Average | 1.36 | 4.34 | 13.90 |
| | St. dev. | 0.01 | 0.03 | 0.20 |
| DK17124-1-38 | Average | 1.90 | 3.52 | 6.53 |
| | St. dev. | 0.11 | 0.04 | 0.47 |
| DK17124-1-49 | Average | 1.72 | 6.50 | 24.58 |
| | St. dev. | 0.05 | 0.04 | 1.06 |
| DK17124-1-51 | Average | 1.47 | 5.33 | 19.37 |
| | St. dev. | 0.06 | 0.14 | 1.91 |
| DK17124-1-52 | Average | 1.39 | 4.27 | 13.12 |
| | St. dev. | 0.04 | 0.01 | 0.42 |
| DK17124-1-53 | Average | 1.72 | 3.42 | 6.81 |
| | St. dev. | 0.07 | 0.03 | 0.17 |

Of interest is the observation that SM90 trials (31-34) where the monoglyceride content is highest, namely 96.50 is not the sample with the smallest water droplet size at 1.2% concentration, as may have been expected. The high concentrations of SM60 and SM80 with monoglyceride contents of 64.56, and 82.87 respectively are lower and similar to each other. This can be taken to suggest that the monoglyceride/diglyceride content of these samples may play a more specific role in adjusting water droplet size than was previously thought.

While the virtues of strong water binding properties of PGPR, are also well known, we have likewise shown that PGPR used alone in W/O low fat emulsions, results in relatively increased volume of water droplet size. Table 12 also shows W/O 40% emulsions samples 61-64 to test PGPR water droplet size distribution, at following inclusions: 0.15, 0.3, 0.6, and 1.2% respectively.

TABLE 12
Shows results of water droplet average volumes for 35% w/o emulsions
samples. These contained empty water phase.

| | Average/ | 2_5% < | 50% < | 97_5% < |
|---|---|---|---|---|
| Sample ID | St. dev. | μm | μm | μm |
| Jr.17026-1-8 | Average | 1.92 | 3.42 | 6.10 |
| | St. dev. | 0.10 | 0.02 | 0.28 |

17026 - 1 - 8 = 0.4% PGPR 90

TABLE 13
Shows W/O 40% emulsions samples 61-64 to test PGPR water droplet
size distribution, at following inclusions: 0.15, 0.3, 0.6, and 1.2%
respectively. Samples with monoglyceride content 96.50%, SM90:
samples 31-33 showed an acceptable emulsion structure, with a thick
and creamy mouth feel and an acceptable in mouth melt profile
indicating good flavour release. Sample 34 gave an acceptable emulsion,
but the mouth feel was not as smooth or creamy, and the melt
profile was slower.

| | Average/ | 2_5% < | 50% < | 97_5% < |
|---|---|---|---|---|
| Sample ID | St. dev. | μm | μm | μm |
| Jr.No.17124-1-61 | Average | 1.46 | 12.54 | 107.93 |
| | St. dev. | 0.05 | 0.46 | 10.39 |
| Jr.No.17124-1-62 | Average | 1.02 | 12.89 | 164.41 |
| | St. dev. | 0.04 | 0.67 | 22.91 |
| Jr.No.17124-1-63 | Average | 0.93 | 6.59 | 47.56 |
| | St. dev. | 0.09 | 0.37 | 9.61 |
| Jr.No.17124-1-64 | Average | 1.82 | 4.23 | 9.84 |
| | St. dev. | 0.03 | 0.05 | 0.27 |

Samples with monoglyceride content of 64.56%, SM60: sample 35 gave an acceptable emulsion, but was duller in appearance, though just as creamy as the preceding samples, but the in mouth melt profile was poorer. Sample 36 gave a better emulsion than sample 35, and was creamy and thicker than sample 35. Sample 37 gave a good thick emulsion and was creamy and thick in the mouth feel. Sample 38 gave a thick emulsion was creamy and thick to taste, but showed a slow melting profile.

Samples of monoglyceride content of 82.87%, SM80: sample 49 gave a good emulsion and was thick and creamy to taste. Sample 51 gave a good shiny emulsion, was thick, but not as creamy as sample 49. Sample 52 gave an acceptable thick emulsion with a creamy taste. Sample 53 gave a very thick emulsion, with an equally thick mouth feel, and poor flavour release.

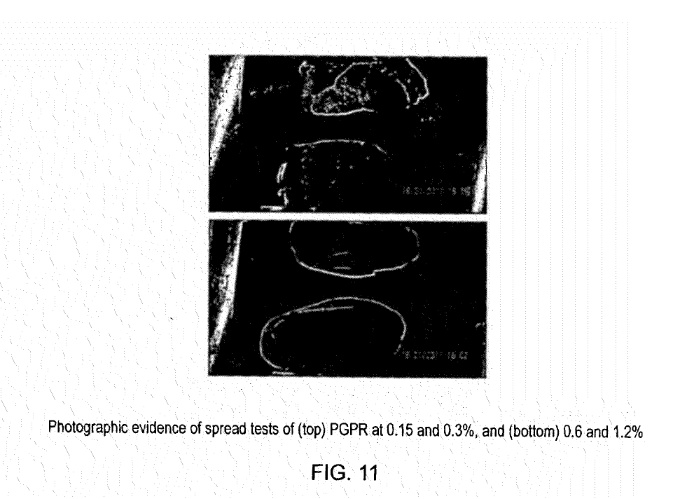

In FIG. 11 the similar spread test results are seen for PGPR samples at 0.15, 0.3, 0.6 and 1.2% dosages. The comments on the emulsions were at 0.15% the emulsion was falling apart, was generally weak and had a watery mouthfeel. At 0.3% there were signs of water separation, with a non-creamy and watery mouthfeel. At 0.6% the emulsion was deemed as acceptable, with the mouthfeel a bit thicker than previously and chewy in character. At the highest dosage of 1.2% the emulsion showed good stability, but the mouthfeel was very chewy.

As is seen from the sensory results and images in FIG. 10, an increase in concentration of the novel mono and diglycerides generally leads to greater emulsion stability increases, but at a cost towards the mouth feel and the flavour release.

To summarise—the novel mono and diglycerides are capable of producing commercially viable spreads.

In general then, the above summary has shown that simply the presence of long chain fatty acids of C₂₂ behenic acid source, as found in GRINDSTED® CRYSTALLIZER 110 are not sufficient to structure and emulsify low fat spread applications of 40% fat content or below. GRINDSTED® CRYSTALLIZER 110 has some 89% of its fatty acids as the behenic acid type, and while good at offering a crystallisation source, must be utilised in combination with other emulsfiers. GRINDSTED® PGPR 90 is known for its emulsification ability, but as has been demonstrated here, is not a good source of crystallisation—as evidenced by the rheology results in Rapeseed oil of Peanut oil. However, the novel mono and diglycerides have been shown to achieve both structuring and emulsification properties. This has been proved in model systems as well as in real application systems, where viable, stable low fat spreads were produced.

### Example 2

### Peanut Butter

Four samples, Samples 2.1, 2.2, 2.3 and 2.4, were used at two concentration levels, 1.5 and 3.0% to make peanut butter.

Further application testing into the performance of fatty acid blends was undertaken, in this case making peanut butter. The aim of this specific trial is to use the blends to produce peanut butter and evaluate against standard peanut butter.

### Materials & Methods

The blend components are given in Table 14. The recipes used to make the peanut butters are given in Tables 15 and 16.

TABLE 14
Fatty acid profiles and Iodine Values of the blends used in the
manufacture of the peanut butter samples.

| | Sample 2.1 | Sample 2.2 | Sample 2.3 | Sample 2.2 |
|---|---|---|---|---|
| | Lot | | | |
| | 2758/020 | 2578/021 | 2671/122 | 2758/023 |
| | E-No. | | | |
| | E120419-1 | E12419-2 | E12419-3 | E120419-4 |
| Calculated IV | 100 | 60 | 40 | 30 |
| IV | 100.7 | 56.7 | 41.7 | 32.5 |
| C12 | 0.0 | 0.0 | 0.1 | <0.1 |
| C14 | 0.1 | 0.1 | 0.1 | 0.1 |
| C16 | 7 | 4.0 | 4.1 | 3.8 |
| C16:1 | 0.1 | 0.1 | 0.2 | 0.1 |
| C17 | 0.1 | 0.1 | 0.1 | 0.1 |
| C18 | 3.8 | 3.2 | 8.0 | 7.2 |
| C18:1 Trans | <0.1 | 0.2 | 34.6 | 26.6 |
| C18:1 CIS | 22.6 | 63.6 | 13.5 | 10.6 |
| C18:2 Trans | 1.1 | 0.2 | 3.1 | 2.2 |
| C18:2 CIS | 59.4 | 8.6 | 0.4 | 0.5 |
| C20 | 0.4 | 1.1 | 2.0 | 2.6 |
| C20:1 | 0.2 | 0.2 | 0.8 | 0.6 |
| C20U | 0.3 | 0.1 | <0.1 | <0.1 |
| C21 | 0.0 | 0.1 | 0.1 | 0.1 |
| C22 | 4.7 | 17.8 | 32.1 | 44.4 |
| C22:1 | 0.0 | 0.0 | 0.3 | 0.2 |
| C24 | 0.2 | 0.5 | 0.6 | 0.8 |
| GL | 0.14 | 0.12 | 0.18 | 0.17 |
| DIGL | 0.22 | 0.22 | 0.24 | 0.25 |
| FFA | 0.4 | 0.3 | 0.4 | 0.3 |
| MONO | 96.64 | 96.49 | 96.57 | 96.40 |
| DI | 2.26 | 2.48 | 1.88 | 1.72 |
| TRI | 0.07 | 0.36 | 0.76 | 1.13 |
| Normalised | 99.93 | 99.74 | 100.65 | 100.95 |
| from | | | | |

TABLE 15
Recipe for peanut butter with 1.5% dosage of the blends.

| Ingredients | | Batch 1 | Batch 2 | Batch 3 | Batch 4 |
|---|---|---|---|---|---|
| Peanut Butter Paste | 90.50% | 9050 | 9050 | 9050 | 9050 |
| Sample 2.1 | 1.50% | 150 | | | |
| Sample 2.2 | 1.50% | | 150 | | |
| Sample 2.3 | 1.50% | | | 150 | |
| Sample 2.4 | 1.50% | | | | 150 |
| Sugar | 6.50% | 650 | 650 | 650 | 650 |
| Salt | 1.50% | 150 | 150 | 150 | 150 |
| | | 10000 | 10000 | 10000 | 10000 |

TABLE 16
Recipe for peanut butter with 3.0% dosage of the blends.

| Ingredients | | Batch 1 | Batch 2 | Batch 3 | Batch 4 |
|---|---|---|---|---|---|
| Peanut Butter Paste | 90.50% | 9050 | 9050 | 9050 | 9050 |
| Sample 2.1 | 3.00% | 300 | | | |
| Sample 2.2 | 3.00% | | 300 | | |
| Sample 2.3 | 3.00% | | | 300 | |
| Sample 2.4 | 3.00% | | | | 300 |
| Sugar | 5.00% | 500 | 500 | 500 | 500 |
| Salt | 1.50% | 150 | 150 | 150 | 150 |
| | | 10000 | 10000 | 10000 | 10000 |

All the samples were stored at 20° C. and were measured for firmness by way of a penetrometer with a cone probe and 50 g weight. Drop lever was pressed for 5 seconds and the distance (mm) travelled by the probe was measured.

### Results & Discussion

The peanut butters were evaluated by a penetration test and visually and the results are expressed in Table 17. The values for peanut butters made with GRINDSTED® PS 105 at 1.5 and 3.0% are taken as standard peanut butters, and are reported from earlier results. GRINDSTED® PS 105 is a blend of edible, refined, fully hydrogenated rapeseed, cottonseed and soybean oils. At each dosage it can be seen that the PS 105 containing peanut butters are firmer than those made with the blends used here. The appearance of standard peanut butter is shiny, but without having an oily surface.

The samples, generally speaking, were dull in appearance, but were deemed acceptable. They were scored as having less sheen than would be the case for production with triglyceride based stabilisers. Those that were liquid, and did not set were considered to have failed since the consistency was not what is expected from a peanut butter spread. Thus, dosages of 3.0% were typically required. Sample 2.4 gave firmness between the range of PS 105 at 1.5% and 3.0% dosage. Indeed, lowering the dosage below 3.0% but greater than 1.5% for this blend may achieve firmness akin to the standard peanut butter.

TABLE 17
Results of the penetrometer tests and visual evaluation of the
peanut butters at two emulsifier concentrations.

| | | Penetrometer | |
|---|---|---|---|
| Stabiliser | Use Level | (mm) | Notes |
| PS 105 | 1.50% | 22.10 | Standard peanut butter |
| Sample 2.1 | 1.50% | 30.05 | Liquid, did not set |
| Sample 2.2 | 1.50% | 30.05 | Liquid, did not set |
| Sample 2.3 | 1.50% | 30.05 | Very soft, oily appearence |
| Sample 2.4 | 1.50% | 30.05 | Very soft, oily appearence |
| PS 105 | 3.00% | 14.00 | Appeared like standard |
| | | | peanut butter but very firm |
| Sample 2.1 | 3.00% | 30.05 | Liquid, did not set |
| Sample 2.2 | 3.00% | 30.05 | Very soft set |
| Sample 2.3 | 3.00% | 30.05 | Set, dull in appearance |
| Sample 2.4 | 3.00% | 17.05 | Firmer set, dull appearance |

It was noted that the samples here were filled at 38° C., which is generally accepted as being the typical temperature for peanut butter. The temperature range which stabilisers in peanut butter are found to function well can be as narrow as 2-3° C. or as large as 6-8° C. If the samples are filled outside these ranges the product will not set correctly.

### Conclusion

Samples 2.2, 2.3 and 2.4, containing the preferred amount of greater than 7 wt % of C22 fatty acid, gave set peanut butters albeit soft and duller than would have been the case with triglyceride production. Optimisation of the setting characteristics could be achieved by varying the filling temperature, and increasing the shininess may be achieved by incorporating some triglyceride. Sample 2.1 did not set at 3 wt % dosage.

All the samples were perceived as being duller than with peanut butters produced with triglyceride, although acceptable.

The firmest sample was recorded for Sample 2.4, and further optimisation of the setting characteristics could be achieved by adjusting the dosage between 1.5 and 3.0% to produce a peanut butter within the range of PS 105 at 1.5%, or optimise filling temperature.

In summary, the samples 2.2, 2.3 and 2.4 were capable of producing viable and acceptable peanut butters.

### Example 3

### Example 3.1

### 40% Low Fat Spread

Four samples of laboratory blended samples were tested in 40% low fat spread applications. The blends were

| Sample 2.1 | Sample 2.2 | Sample 2.3 | Sample 2.2 |
|---|---|---|---|
| 2758/020 | 2578/021 | 2671/122 | 2758/023 |

This example investigates the effect of varying dosages of a range of fat blends in 40% low fat spreads.

### Materials & Methods

For brevity the methods used are concurrent with those described herein with respect to water droplet size distribution, texture analysis and visual evaluation covering spread testing.

The recipes used are as follows in Table 18 showing the different dosages (0.15, and 0.6%) of each blend.

The procedure in each case is;

Water phase:

1. Heat water to 80° C.
2. Mix dry ingredients
3. Slowly add dry ingredients to the water while stirring intensively. Stir for 4 minutes.
4. Cool water phase to 50° C.
5. Re-weigh and add water equivalent to the amount of evaporation
6. Adjust pH with citric acid or NaOH
7. Add flavour just before running the Perfector

Fat phase:

1. Weigh out emulsifier, beta carotene (2% solution) and oil/fat in the same container

### 2. Heat to 80° C.

3. Stir the fat phase until mixed well
4. Cool the fat phase to 50° C.
5. Add flavour just before running the Perfector

Emulsion:

Add the water phase to the fat phase stirring intensively

TABLE 18
The recipes used for the 40% fat spread
trials at 0.15 and 0.6% dosages.
Ingredients in % (Standard recipes)

| Ingredient Name | 1 | 3 |
|---|---|---|
| Water (Tap) | 57.800 | 57.800 |
| Salt (Sodium Chloride) | 0.500 | 0.500 |
| GRINDSTED ® LFS 560 | 1.500 | 1.500 |
| Stabiliser System | | |
| Skimmed milk powder | 0.100 | 0.100 |
| Potassium Sorbate | 0.100 | 0.100 |
| Water phase total | 60.000 | 60.000 |
| pH | 5.5 | 5.5 |
| PK4 - INES | 25.000 | 25.000 |
| COLZAO | 75.000 | 75.000 |
| Fat blend total | 100.000 | 100.000 |
| DIMODAN ® U/J | 0.150 | 0.600 |
| Distilled Monoglyceride | | |
| GRINDSTED ® PGPR 90 | 0.100 | 0.100 |
| Polyglycerol | | |
| Polyricinoleate | | |
| 2% sol. beta-carotene | 0.020 | 0.020 |
| Butter Flavouring | 0.020 | 0.020 |
| 050001 T04184 | | |
| Other fat ingredients total | 0.290 | 0.740 |
| Fat phase total | 40.000 | 40.000 |
| RECIPE total | 100.000 | 100.000 |
| (calc. batchsize) | | |

Ingredients in %

| Ingredient Name | 11 | 13 | 15 | 17 |
|---|---|---|---|---|
| Water (Tap) | 57.800 | 57.800 | 57.800 | 57.800 |
| Salt (Sodium Chloride) | 0.500 | 0.500 | 0.500 | 0.500 |
| GRINDSTED ® LFS 560 | 1.500 | 1.500 | 1.500 | 1.500 |
| Stabiliser System | | | | |
| Skimmed milk powder | 0.100 | 0.100 | 0.100 | 0.100 |
| Potassium Sorbate | 0.100 | 0.100 | 0.100 | 0.100 |
| Water phase total | 60.000 | 60.000 | 60.000 | 60.000 |
| pH | 5.5 | 5.5 | 5.5 | 5.5 |
| PK4 - INES | 25.000 | 25.000 | 25.000 | 25.000 |
| COLZAO | 75.000 | 75.000 | 75.000 | 75.000 |
| Fat blend total | 100.000 | 100.000 | 100.000 | 100.000 |
| Lot no. 2758/021 | 0.150 | 0.600 | | |
| Lot no. 2758/023 | | | 0.150 | 0.600 |
| GRINDSTED ® PGPR 90 | 0.100 | 0.100 | 0.100 | 0.100 |
| Polyglycerol | | | | |
| Polyricinoleate | | | | |
| 2% sol. beta-carotene | 0.020 | 0.020 | 0.020 | 0.020 |
| Butter Flavouring | 0.020 | 0.020 | 0.020 | 0.020 |
| 050001 T04184 | | | | |
| Other fat | 0.290 | 0.740 | 0.290 | 0.740 |
| ingredients total | | | | |
| Fat phase total | 40.000 | 40.000 | 40.000 | 40.000 |
| RECIPE total | 100.000 | 100.000 | 100.000 | 100.000 |
| (calc. batchsize) | | | | |

Ingredients in %

| Ingredient Name | 21 | 23 | 25 | 27 |
|---|---|---|---|---|
| Water (Tap) | 57.800 | 57.800 | 57.800 | 57.800 |
| Salt (Sodium Chloride) | 0.500 | 0.500 | 0.500 | 0.500 |
| GRINDSTED ® LFS 560 | 1.500 | 1.500 | 1.500 | 1.500 |
| Stabiliser System | | | | |
| Skimmed milk powder | 0.100 | 0.100 | 0.100 | 0.100 |
| Potassium Sorbate | 0.100 | 0.100 | 0.100 | 0.100 |
| Water phase total | 60.000 | 60.000 | 60.000 | 60.000 |
| pH | 5.5 | 5.5 | 5.5 | 5.5 |
| PK4 - INES | 25.000 | 25.000 | 25.000 | 25.000 |
| COLZAO | 75.000 | 75.000 | 75.000 | 75.000 |
| Fat blend total | 100.000 | 100.000 | 100.000 | 100.000 |
| Lot no. 2671/122 | 0.150 | 0.600 | | |
| Lot no. 2758/020 | | | 0.150 | 0.600 |
| GRINDSTED ® PGPR 90 | 0.100 | 0.100 | 0.100 | 0.100 |
| Polyglycerol | | | | |
| Polyricinoleate | | | | |
| 2% sol. beta-carotene | 0.020 | 0.020 | 0.020 | 0.020 |
| Butter Flavouring | 0.020 | 0.020 | 0.020 | 0.020 |
| 050001 T04184 | | | | |
| Other fat | 0.290 | 0.740 | 0.290 | 0.740 |
| ingredients total | | | | |
| Fat phase total | 40.000 | 40.000 | 40.000 | 40.000 |
| RECIPE total | 100.000 | 100.000 | 100.000 | 100.000 |
| (calc. batchsize) | | | | |

The process conditions are given in Table 19 for one only, but are identical for each recipe made;

Pilot Plant

| Processing (3-tube lab perfector): | 1 |
|---|---|
| Oil phase temperature | 50 |
| Water phase temperature | 50 |
| Emulsion temperature | 50 |
| Centrifugal pump | Auto |
| Capacity high pressure pump | 40 |
| Cooling (NH3) tube 1: | −10 |
| Cooling (NH3) tube 2: | −10 |
| Cooling (NH3) tube 3: | |
| Rpm tube 1: | 1000 |
| Rpm tube 2: | 1000 |

### Results & Discussion

The results from the water droplet size are given in Table 20.

TABLE 20
Water droplet size distribution data for the 40% LFS samples.

| | Average/ | 2.5% | 50% | 97.5% |
|---|---|---|---|---|
| Sample ID | St.dev. | <μm | <μm | <μm |
| DK19402-3(DK)-1 | Average | 1.92 | 6.44 | 21.61 |
| | St.dev. | 0.03 | 0.07 | 0.74 |
| DK19402-3(DK)-3 | Average | 1.71 | 5.35 | 16.80 |
| | St.dev. | 0.06 | 0.17 | 1.46 |
| DK19402-3(DK)-1 [symbol] | Average | 1.61 | 5.75 | 20.63 |
| | St.dev. | 0.04 | 0.10 | 1.11 |
| DK19402-3(DK)-1 [symbol] | Average | 1.63 | 4.32 | 11.46 |
| | St.dev. | 0.05 | 0.02 | 0.35 |
| DK19402-3(DK)-1 [symbol] | Average | 1.06 | 4.87 | 22.39 |
| | St.dev. | 0.02 | 0.03 | 0.45 |
| DK19402-3(DK)-1 [symbol] | Average | 0.71 | 4.35 | 26.83 |
| | St.dev. | 0.01 | 0.09 | 0.93 |
| DK19402-3(DK)-2 [symbol] | Average | 1.02 | 4.91 | 23.76 |
| | St.dev. | 0.06 | 0.04 | 1.23 |
| DK19402-3(DK)-2 [symbol] | Average | 1.10 | 4.26 | 16.45 |
| | St.dev. | 0.02 | 0.02 | 0.19 |
| DK19402-3(DK)-2 [symbol] | Average | 1.56 | 5.75 | 21.28 |
| | St.dev. | 0.02 | 0.27 | 1.78 |
| DK19402-3(DK)-2 [symbol] | Average | 1.67 | 5.25 | 16.57 |
| | St.dev. | 0.04 | 0.29 | 1.46 |

[symbol]

indicates data missing or illegible when filed

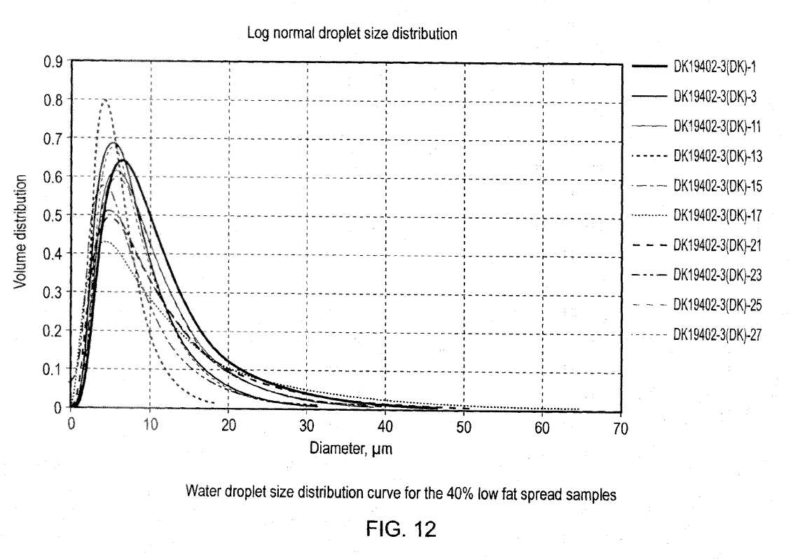

The data reported here shows that for each sample, irrespective of concentration used, the water droplet size is concurrent with stable spreads. These results indicate that within this concentration range and in combination with PGPR the blends are able to form stable, viable low fat spreads. Graphically, the data from Table 20 is expressed in FIG. 12.

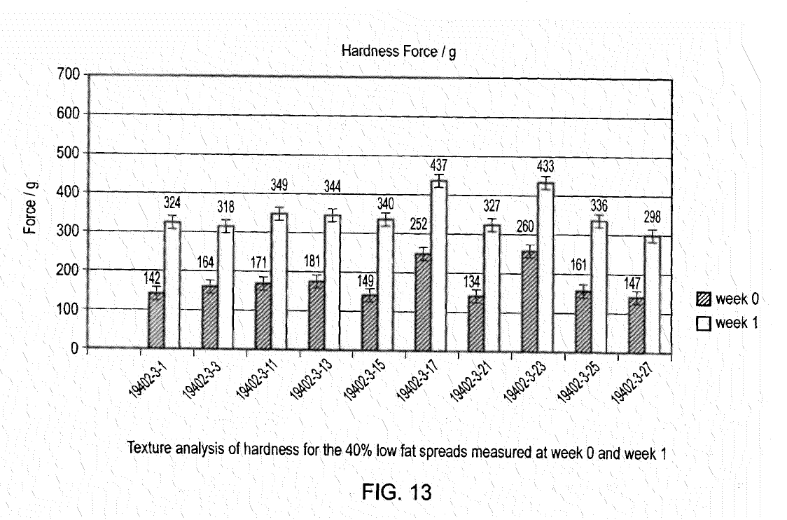

The hardness results are measured at week 0 and after one week. These results are given in FIG. 13.

The initial observation is that there is significant texture development from the initial measurement and after one week, and that there is generally no real increase in texture as a function of concentration with the exception of 17 and 23 which are both at 0.6% concentration with 0.1% PGPR and the samples are Samples 2.4 and Sample 2.3 respectively. All other blends are essentially similar, also with what can be taken as the standards samples 1 and 3. For the two blends highlighted, maybe the dosages can be reduced to give spreads which are more in line with standard spreads, and thereby offer potential cost-in-use savings.

### Conclusion

The main conclusion from this example is that viable 40% low fat spreads can be made from the blends of the present invention.

### Example 3.2

### 40% Low Fat Spread for Reworking

Four laboratory blends were tested in 40% low fat spread with re-working.

In this example we investigate whether the blends of the present invention allow for re-working.

### Materials & Methods

The recipe used for the samples is given in Table 21. The procedure for their preparation is as in Example 3.1

TABLE 21
Recipes used to make 40% low fat spreads for re-work testing.

| Ingredient Name | 1 | 3 | 5 | 7 |
|---|---|---|---|---|
| Water (Tap) | 57.300 | 57.300 | 57.300 | 57.300 |
| Salt (Sodium Chloride) | 1.000 | 1.000 | 1.000 | 1.000 |
| GRINDSTED ® LFS 560 | 1.500 | 1.500 | 1.500 | 1.500 |
| Stabiliser System | | | | |
| Skimmed milk powder | 0.100 | 0.100 | 0.100 | 0.100 |
| Potassium Sorbate | 0.100 | 0.100 | 0.100 | 0.100 |
| Water phase total | 60.000 | 60.000 | 60.000 | 60.000 |
| pH | 5.5 | 5.5 | 5.5 | 5.5 |
| PK4 - INES | 25.000 | 25.000 | 25.000 | 25.000 |
| COLZAO | 75.000 | 75.000 | 75.000 | 75.000 |
| Fat blend total | 100.000 | 100.000 | 100.000 | 100.000 |
| Lot no. 2758/021 | 0.500 | | | |
| Lot no. 2758/023 | | 0.500 | | |
| Lot no. 2671/122 | | | 0.500 | |
| Lot no. 2758/020 | | | | 0.500 |
| 2% sol. beta-carotene | 0.020 | 0.020 | 0.020 | 0.020 |
| Other fat | 0.520 | 0.520 | 0.520 | 0.520 |
| ingredients total | | | | |
| Fat phase total | 40.000 | 40.000 | 40.000 | 40.000 |
| RECIPE total | 100.000 | 100.000 | 100.000 | 100.000 |
| (calc. batchsize) | | | | |

The conditions recorded on the pilot plant are given in Table 22.

TABLE 22
Process conditions on the pilot plant for
the 40% low fat spread re-working samples.

| Processing (3-tube lab perfector): | 1 | 3 | 5 | 7 |
|---|---|---|---|---|
| Oil phase temperature | 50 | 50 | 50 | 50 |
| Water phase temperature | 50 | 50 | 50 | 50 |
| Emulsion temperature | 50 | 50 | 50 | 50 |
| Centrifugal pump | Auto | Auto | Auto | Auto |
| Capacity high pressure pump | 40 | 40 | 40 | 40 |
| Cooling (NH3) tube 1: | −10 | −10 | −10 | −10 |
| Cooling (NH3) tube 2: | −10 | −10 | −10 | −10 |
| Cooling (NH3) tube 3: | | | | |
| Rpm tube 1: | 1000 | 1000 | 1000 | 1000 |
| Rpm tube 2: | 1000 | 1000 | 1000 | 1000 |

After the preparation of the emulsion, the emulsion is run through the re-melter and the samples are tapped after re-melting

### Results & Discussion

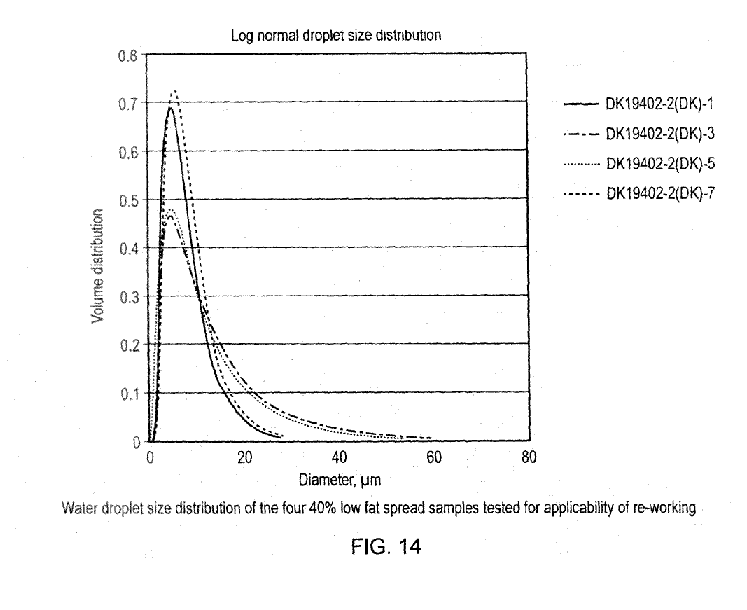

The water droplet size distribution results are given for the four samples in Table 23, and graphically in FIG. 14. The results show that sample 1 and sample 7; and sample 3 and sample 5 are similar to each other respectively.

TABLE 23
Water droplet size distribution for 40% low fat spreads
made with blends at 0.5% dosage for re-working.

| | Average/ | 2.5% | 50% | 97.5% |
|---|---|---|---|---|
| Sample ID | St.dev. | <μm | <μm | <μm |
| DK19402-2(DK)-1 | Average | 1.62 | 5.07 | 15.89 |
| | St.dev | 0.01 | 0.08 | 0.47 |
| DK19402-2(DK)-3 | Average | 0.89 | 4.86 | 26.37 |
| | St.dev. | 0.02 | 0.01 | 0.51 |
| DK19402-2(DK)-5 | Average | 0.94 | 4.81 | 24.73 |
| | St.dev | 0.07 | 0.14 | 3.39 |
| DK19402-2(DK)-7 | Average | 1.93 | 5.71 | 16.94 |
| | St.dev | 0.05 | 0.11 | 0.81 |

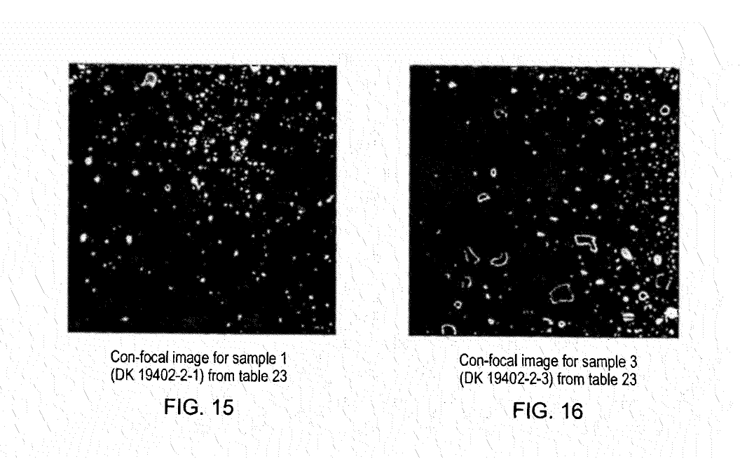

The con-focal image of sample 1 (DK 19402-2-1), with the lowest water droplet size is given in FIG. 15 along with that for sample 3 (DK 19402-2-3) with the highest water droplet size in FIG. 16.

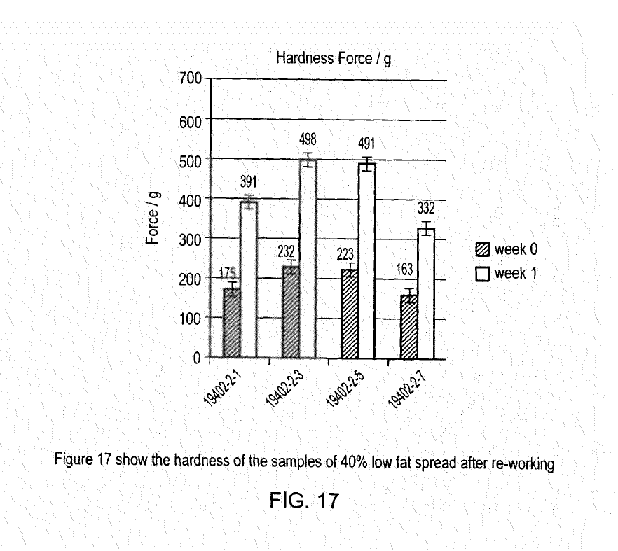

The hardness of the samples is given in FIG. 17. The hardness after one week was 251251 g and 324 g respectively. There is no evidence to suggest that any of these samples would be classified as being failures in terms of being able to sustain a viable product even after re-working.

### Conclusion

In each case the samples were given to indicate that viable 40% low fat spreads could be produced with experimental values for water droplet size, con-focal laser microscopy and texture analysis being concurrent with previously reported values.

The values recorded for water droplet size distribution, con-focal laser microscopy images, and texture analysis results are within the range of acceptable sample values for both 40% low fat spread produced with and without re-working.

### Example 4

### 82% Fat Spread

Four samples of laboratory blended samples were tested in 82% high fat retail margarine. The blends were

| Sample 2.1 | Sample 2.2 | Sample 2.3 | Sample 2.2 |
|---|---|---|---|
| 2758/020 | 2578/021 | 2671/122 | 2758/023 |

### Materials & Methods

The recipes used are given in Table 24a and 24b.

TABLE 24a
Recipe of high fat (82%) retails spread

| Ingredient Name | 1 |
|---|---|
| Water (Tap) | 16.400 |
| Salt (Sodium Chloride) | 0.500 |
| Skimmed milk powder | 1.000 |
| Potassium Sorbate | 0.100 |
| Water phase total | 18.000 |
| pH | 5.5 |
| PK4 - INES | 25.000 |
| COLZAO | 75.000 |
| Fat blend total | 100.000 |
| DIMODAN ® HP Distilled | 0.200 |
| Monoglyceride | |
| 2% sol. beta-carotene | 0.020 |
| Butter Flavouring | 0.020 |
| 050001 T04184 | |
| Other fat | 0.240 |
| ingredients total | |
| Fat phase total | 82.000 |
| RECIPE total | 100.000 |
| (calc. batchsize) | |

TABLE 24b
Recipes of high fat (82%) retail spread

| Ingredient Name | 11 | 13 | 15 | 17 |
|---|---|---|---|---|
| Water (Tap) | 16.400 | 16.400 | 16.400 | 16.400 |
| Salt (Sodium Chloride) | 0.500 | 0.500 | 0.500 | 0.500 |
| Skimmed milk powder | 1.000 | 1.000 | 1.000 | 1.000 |
| Potassium Sorbate | 0.100 | 0.100 | 0.100 | 0.100 |
| Water phase total | 18.000 | 18.000 | 18.000 | 18.000 |
| pH | 5.5 | 5.5 | 5.5 | 5.5 |
| PK4 - INES | 25.000 | 25.000 | 25.000 | 25.000 |
| COLZAO | 75.000 | 75.000 | 75.000 | 75.000 |
| Fat blend total | 100.000 | 100.000 | 100.000 | 100.000 |
| Lot no. 2758/021 | 0.200 | | | |
| Lot no. 2758/023 | | 0.200 | | |
| Lot no. 2671/122 | | | 0.200 | |
| Lot no. 2758/020 | | | | 0.200 |
| 2% sol. beta-carotene | 0.020 | 0.020 | 0.020 | 0.020 |
| Butter Flavouring | 0.020 | 0.020 | 0.020 | 0.020 |
| 050001 T04184 | | | | |
| Other fat | 0.240 | 0.240 | 0.240 | 0.240 |
| ingredients total | | | | |
| Fat phase total | 82.000 | 82.000 | 82.000 | 82.000 |
| RECIPE total | 100.000 | 100.000 | 100.000 | 100.000 |
| (calc. batchsize) | | | | |

The procedure is given in Example 3.1

The analyses carried out include water droplet size analysis, con-focal laser scanning microscopy, texture analysis and visual evaluation which includes spread testing.

### Results & Discussion

The results for water droplet size distribution are given in Table 25 and conform to the expectations of water droplet size for this type of application.

TABLE 25
water droplet size distribution analysis of the 82% fat retail margarine
samples made with the blends given in Table 24a, and 24b.

| | Average/ | 2.5% | 50% | 97.5% |
|---|---|---|---|---|
| Sample ID | St.dev. | <μm | <μm | <μm |
| DK19402-4(DK)-1 | Average | 0.96 | 2.38 | 5.92 |
| | St.dev. | 0.03 | 0.03 | 0.06 |
| DK19402-4(DK)-11 | Average | 1.05 | 2.41 | 5.56 |
| | St.dev. | 0.10 | 0.04 | 0.38 |
| DK19402-4(DK)-13 | Average | 0.86 | 2.22 | 5.94 |
| | St.dev. | 0.24 | 0.14 | 0.83 |
| DK19402-4(DK)-15 | Average | 0.98 | 2.36 | 5.71 |
| | St.dev. | 0.06 | 0.07 | 5.19 |
| DK19402-4(DK)-17 | Average | 1.90 | 3.12 | 5.19 |
| | St.dev. | 0.27 | 0.06 | 0.51 |

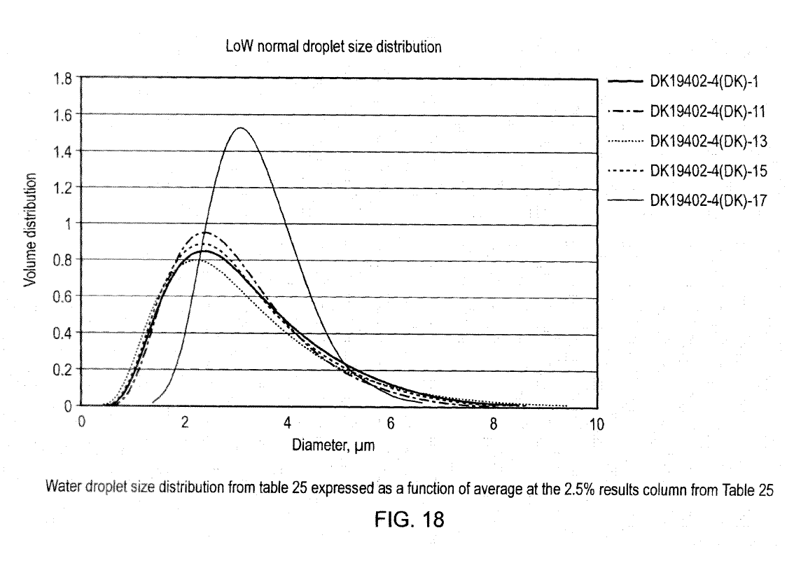

Graphically this is shown in FIG. 18 where the data refer to the water droplet size at the 2.5% column from Table 25. The distribution is generally narrow for the samples corresponding to nos. 1, 11, 13, 15; with only sample 17 being different. However, this difference is not going to play a significant role on the over structure of the corresponding 82% fat spread.

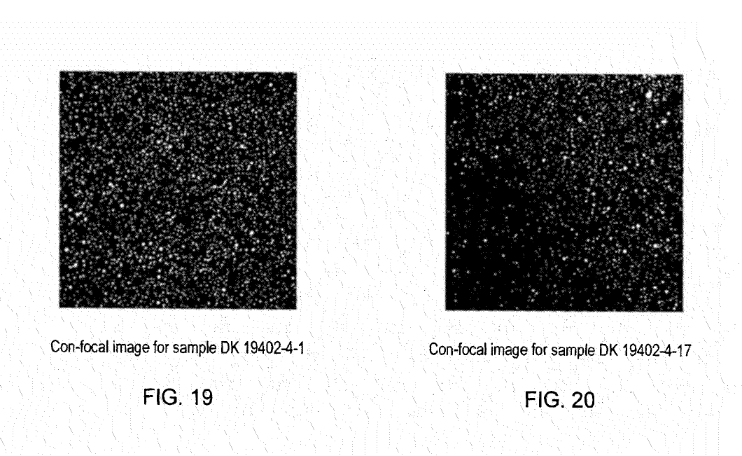

Taking sample 1 as representative of the group 1, 11, 13, 15, the con-focal image of this is given in FIG. 19, as is the con-focal image for sample 17 in FIG. 20.

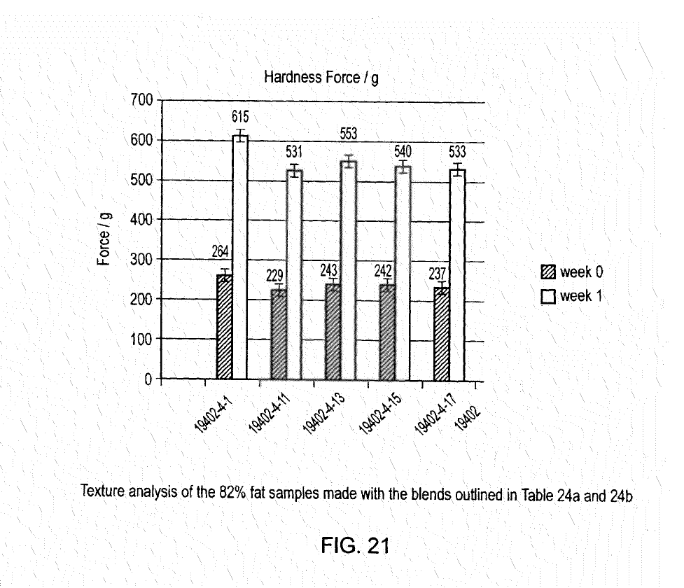

The texture analysis for these samples giving the measured hardness at two different times: time 0 and after one week is given in FIG. 21.

### Conclusion

Results show that all samples produced viable 82% high fat retail margarines. The results confirm that such laboratory blended samples can be made and lead to application samples with satisfactory water droplet size distribution, con-focal laser scanning microscopy and texture analysis results.

### Example 5

### Cake Margarine and Cake

This example investigates the ability of the present compositions to produce a viable cake margarine followed by the subsequent production of viable cakes. Four samples of laboratory blended samples were tested in cake margarine and then in cake production. The blends were

| Sample 2.1 | Sample 2.2 | Sample 2.3 | Sample 2.2 |
|---|---|---|---|
| 2758/020 | 2578/021 | 2671/122 | 2758/023 |

### Materials & Methods

The recipes for the four cake margarines are given in Table 26.

The procedure is given as follows:

Water phase:

1. Mix tap water (10°-20° C.), potassium sorbate. EDTA, salt and protein on stirring device for approx. 1 min.
2. Adjust pH with citric acid or NaOH

Fat phase:

1. Weigh out emulsifier, beta carotene (2% solution) and oil/fat in the same container

### 2. Heat to 80° C.

3. Stir the fat phase until mixed well
4. Cool the fat phase to 60° C.
5. Add flavour just before running the Perfector

Emulsion:

Add the water phase to the fat phase while stirring

TABLE 26
Recipe for the production of the cake margarines with the 4 blends

| | | | | | |
|---|---|---|---|---|---|
| Ingredient Name | 1 | 2 | 3 | 4 | 5 |

Ingredients in %
Water phase

| | | | | | |
|---|---|---|---|---|---|
| Water (Tap) | 18.900 | 18.900 | 18.900 | 18.900 | 18.900 |
| Salt (Sodium Chloride) | 1.000 | 1.000 | 1.000 | 1.000 | 1.000 |
| Potassium Sorbate | 0.100 | 0.100 | 0.100 | 0.100 | 0.100 |
| Water phase total | 20.000 | 20.000 | 20.000 | 20.000 | 20.000 |
| pH | 5.5 | 5.5 | 5.5 | 5.5 | 5.5 |

Fat phase
Fat blend

| | | | | | |
|---|---|---|---|---|---|
| PALMOTEX ™ B | 40.000 | 40.000 | 40.000 | 40.000 | 40.000 |
| PK4 - INES | 25.000 | 25.000 | 25.000 | 25.000 | 25.000 |
| COLZAO | 35.000 | 35.000 | 35.000 | 35.000 | 35.000 |
| Fat blend total | 100.000 | 100.000 | 100.000 | 100.000 | 100.000 |

Other fat ingredients

| | | | | | |
|---|---|---|---|---|---|
| DIMODAN ® HP Distilled | 0.200 | | | | |
| Monoglyceride | | | | | |
| Lot No. 2758/021 | | 0.200 | | | |
| Lot no. 2758/023 | | | 0.200 | | |
| Lot No. 2671/122 | | | | 0.200 | |
| Lot No. 2758/020 | | | | | 0.200 |
| GRINDSTED ® PGE 20 VEG | 0.750 | 0.750 | 0.750 | 0.750 | 0.750 |
| Polyglycerol Ester | | | | | |
| VEROLEC NON GMO IP, | 0.200 | 0.200 | 0.200 | 0.200 | 0.200 |
| Soybean lecithin | | | | | |
| 2% sol. beta-carotene | 0.025 | 0.025 | 0.025 | 0.025 | 0.025 |
| Butter Flavouring | 0.020 | 0.020 | 0.020 | 0.020 | 0.020 |
| 555504 T | | | | | |
| Other fat | 1.195 | 1.195 | 1.195 | 1.195 | 1.195 |
| ingredients total | | | | | |
| Fat phase total | 80.000 | 80.000 | 80.000 | 80.000 | 80.000 |
| RECIPE total | 100.000 | 100.000 | 100.000 | 100.000 | 100.000 |
| (calc. batchsize) | | | | | |

The processing conditions from the pilot plant are given in Table 27.

TABLE 27
Processing conditions used on the pilot
plant for cake margarine production.

| Processing (3-tube lab perfector): | 1 | 2 | 3 | 4 | 5 |
|---|---|---|---|---|---|
| Oil phase temperature | 60 | 60 | 60 | 60 | 60 |
| Water phase temperature | 20 | 20 | 20 | 20 | 20 |
| Emulsion temperature | 50 | 50 | 50 | 50 | 50 |
| Centrifugal pump | Auto | Auto | Auto | Auto | Auto |
| Capacity high pressure pump | 50 | 50 | 50 | 50 | 50 |
| Cooling (NH3) tube 1: | −15 | −15 | −15 | −15 | −15 |
| Cooling (NH3) tube 2: | −15 | −15 | −15 | −15 | −15 |
| Cooling (NH3) tube 3: | −5 | −5 | −5 | −5 | −5 |
| Rpm tube 1: | 700 | 700 | 700 | 700 | 700 |
| Rpm tube 2: | 700 | 700 | 700 | 700 | 700 |
| Rpm tube 3: | 700 | 700 | 700 | 700 | 700 |
| Intermediate crystallizer | Yes | Yes | Yes | Yes | Yes |
| After tube no? | 1; 2 | 1; 2 | 1; 2 | 1; 2 | 1; 2 |
| Pinning machine | Yes | Yes | Yes | Yes | Yes |
| After tube no? | 2 | 2 | 2 | 2 | 2 |
| Rmp: | 200 | 200 | 200 | 200 | 200 |
| Outlet temperature | 18-20 | 18-20 | 18-20 | 18-20 | 18-20 |

The recipe for the cake production itself is given in Table 28.

TABLE 28
recipe used for the baking of the cakes made with the 4 blends.
Straight Dough Recipe (grams)

| Ingredient Name | 1 | 2 | 3 | 4 | 5 | 6 |
|---|---|---|---|---|---|---|
| Sucrose | 249.00 | 249.00 | 249.00 | 249.00 | 249.00 | 199.36 |
| \|LH2010 | | | | | | |
| Albatros | 124.00 | 124.00 | 124.00 | 124.00 | 124.00 | 99.28 |
| DK2011-00111\|- | | | | | | |
| Wheat starch, Native | 124.00 | 124.00 | 124.00 | 124.00 | 124.00 | 99.28 |
| \|4011653866 | | | | | | |
| Bakingpowder BPHS 003 | 5.000 | 5.000 | 5.000 | 5.000 | 5.000 | 4.003 |
| 403405\|70123466 | | | | | | |
| Cake margarine | 249.00 | | | | | 199.36 |
| Fast\|03-11-2012 | | | | | | |
| Liquid eggs | 249.00 | 249.00 | 249.00 | 249.00 | 249.00 | 199.36 |
| -\|058334-1-2111 | | | | | | |
| DK19402-5-1 1\|- | | 249.00 | | | | |
| DK19402-5-2 2\|- | | | 249.00 | | | |
| DK19402-5-3 3\|- | | | | 249.00 | | |
| DK19402-5-4 4\|- | | | | | 249.00 | |
| DK19402-5-5 5\|- | | | | | | 199.36 |
| Calculated batch size | 1000.00 | 1000.00 | 1000.00 | 1000.00 | 1000.00 | 1000.00 |
| Entered batch size | 1000.00 | 1000.00 | 1000.00 | 1000.00 | 1000.00 | 1000.00 |

The procedure for making the cakes is given as follows, where all ingredients were pre-tempered to room temperature:

1) Scale all dry ingredients and margarine into the bowl.
2) add liquids while mixing in 1st speed
3) Mix for 1 minute at 1st speed—scrape down
4) Mix for 1 minute at 2nd speed—scrape down
5) Mix for 2 minutes at 3rd speed
6) Measure the volume of the batter in 1 dl cup
7) The pound cake tins are sprayed with oil spread and covered with paper
8) Scale 2×350 g into the pound cake tins
9) Spread out the mass evenly with a spatula
10) Bake for 40 minutes at 180° C.
11) After baking—take the tins out of the oven—“drop” it on the table before taking the cakes out of the tins
12) Take paper off the cakes and turn the right side up
13) The cakes are cooled on a grating for 60 minutes before weighing and measuring of the volume.

### Results & Discussion

It was visually noted within the pilot plant that each sample of cake margarine produced was viable and stable. The samples were then handed to the bakery to make the cakes and await evaluation.

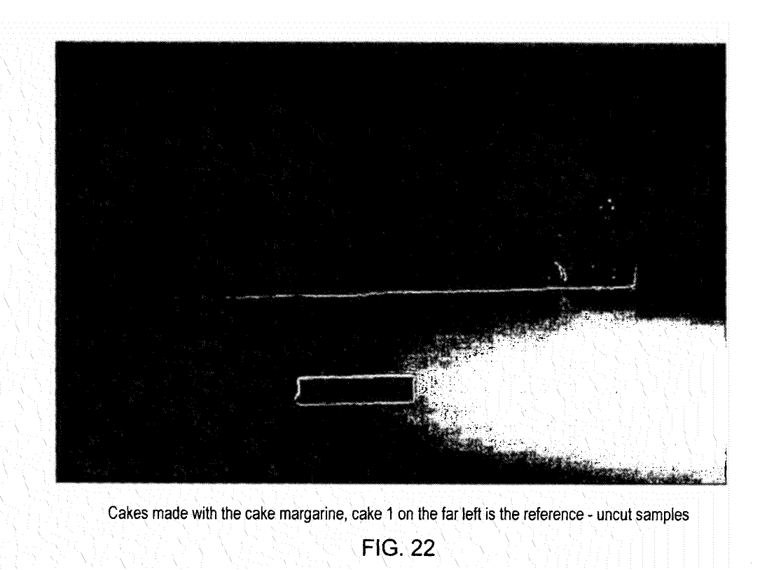

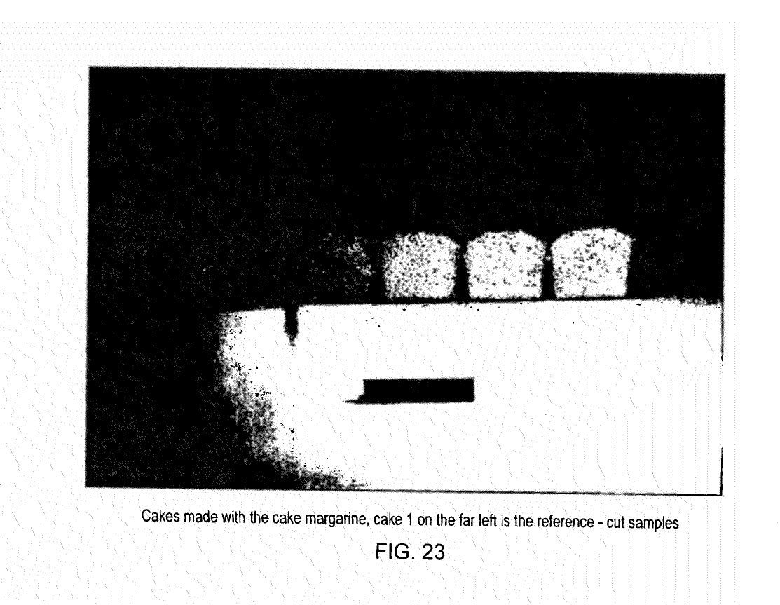

All the samples gave a larger volume when compared to the reference cake (Sample 1 from Table 28). Cakes 1 and 2 gave desirable cracking down the middle of the top of the cake, whereas the rest were weakly cracked if at all. All cakes showed a fine dense crumb structure with cakes 2-6 being softer than the reference sample. Pictorially, the cakes are shown in FIGS. 22 (uncut) and 23 (cut).

The results relating to cake volume, specific volume and weight are presented in Table 29.

TABLE 29
Cake volume, Specific volume and Weight values for the cakes
made according to the recipe outlined in Table 28.

| Cake | Volume | SpecVol | Weight |
|---|---|---|---|
| 1 | 816.5512 | 2.603666 | 314 |
| 2 | 819.5437 | 2.655481 | 309 |
| 3 | 826.1059 | 2.668083 | 310 |
| 4 | 811.6273 | 2.6384 | 308 |
| 5 | 851.5569 | 2.750184 | 310 |
| 6 | 703.2774 | 2.235801 | 315 |

Table 29 shows that only cake 6 has a lower specific volume compared to the standard (cake 1), while the remaining cakes are essentially the same. Cake 6 also has the lowest volume of all cakes tested. The weight of all cakes tested is within 2% of the reference. Therefore, in summary, the cake margarines made with the present blends have proved capable of producing viable cakes.

### Conclusion

Subsequent baking of cakes revealed that acceptable viable cakes were also able to be baked, where weight differences of not more than 2% from the standard were achieved. Only cake 6, corresponding to cake margarine 5 showed lower volume or specific volume than the reference.

All cake margarines made from the present blends were shown to produce viable and acceptable cakes, which had weights which differed from the reference cake by not more than 2%, and had volumes and specific volumes which were essentially similar. Only cake 6 from Table 28 and 29 was an outlier with respect to volume and specific volume, which corresponds to cake margarine 5 from Table 26.

### REFERENCES

Awad, T., Hamada, Y., and Sato, K. (2001) “Effects of addition of diaculyglycerols on fat crystallisation in oil-in-water emulsion.” Eur. J. Lipis Sci. Technol., 103 735-741.
Kyriakidis, N. B. and Katsiloulis, T. (2000) “Calculation of iodine value from measurements of fatty acid methylesters of some oils: Comparison with relevant American Oil Chemists Society method”, JOACS 77(12), 1235-1238.
Mullin, J. W. (1993) “Crystallisation” 3^{rd} Edition. Butterworth-Heinemann, UK, pp 292-293.
Smith, K. W, Bhaggan, K., Talbot, G., and van Malssen, K. F. (2011) “Crystallisation of fats: Influence of minor components and additives.” JOACS, DOI 10.1007/s11747-011-1819-7.
Wassell, P., Bonwick, G., Smith, C. J., Almiron-Roig, E., and Young, N. W. G. (2010) “Towards a multidisciplinary approach to structuring in reduced saturated fat-based systems—a review.” International Journal of Food Science and Technology 45 (4) 642-655.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A composition comprising monoglycerides and diglycerides, wherein the monoglycerides and diglycerides have an iodine value of at least 30, and wherein the fatty acids of the monoglycerides and diglycerides contain C22 fatty acids in an amount of at least 4.5 wt % based on the total amount of fatty acids of the monoglycerides and diglycerides.

2. A composition according to claim 1 wherein the monoglycerides and diglycerides have an iodine value of at least 40.

3. A composition according to claim 1 wherein the monoglycerides and diglycerides have an iodine value of at least 50.

4. A composition according to claim 1 wherein the monoglycerides and diglycerides have an iodine value of at least 60.

5. A composition according to claim 1 wherein the monoglycerides and diglycerides have an iodine value of no greater than 90.

6. A composition according to claim 1 wherein the fatty acids of the monoglycerides and diglycerides contain C22 fatty acids in an amount of at least 7 wt % based on the total amount of fatty acids of the monoglycerides and diglycerides.

7. A composition according to claim 1 wherein the fatty acids of the monoglycerides and diglycerides contain C22 fatty acids in an amount of at least 10 wt % based on the total amount of fatty acids of the monoglycerides and diglycerides.

8. A composition according to claim 1 wherein the fatty acids of the monoglycerides and diglycerides contain C22 fatty acids in an amount of no greater than 80 wt % based on the total amount of fatty acids of the monoglycerides and diglycerides.

9. A composition according to claim 1 wherein the fatty acids of the monoglycerides and diglycerides contain C22 fatty acids in an amount of no greater than 60 wt % based on the total amount of fatty acids of the monoglycerides and diglycerides.

10. A composition according to claim 1 wherein the fatty acids of the monoglycerides and diglycerides contain C22 fatty acids in an amount of no greater than 40 wt % based on the total amount of fatty acids of the monoglycerides and diglycerides.

11. A composition according to claim 1 wherein the fatty acids of the monoglycerides and diglycerides contain C22 fatty acids in an amount of from 10 to 31 wt % based on the total amount of fatty acids of the monoglycerides and diglycerides.

12. A composition according to claim 1 wherein the fatty acids of the monoglycerides and diglycerides comprise saturated C22 fatty acid.

13. A food or feed comprising
(i) a foodstuff; and
(ii) the composition of claim 1.

14. A food or feed according to claim 13 wherein the food or feed is an emulsion.

15. A food or feed according to claim 14 wherein the emulsion is a water in oil emulsion.

16. A food according to claim 13 wherein the food is selected from the group consisting of spreads, bakery margarine, cake margarine, chocolate, compound chocolate, ice cream, and liquid bread improvers.

17. A feed according to claim 13 wherein the feed is selected from the group consisting of poultry feed, aqua culture feed, bovine feed and porcine feed.

18. A process for preparing a food or feed, the process comprising the steps of
(i) providing a foodstuff; and
(ii) contacting the foodstuff with the composition of claim 1.

19. An emulsifier comprising the composition of claim 1.

20. A crystallisation improver comprising the composition of claim 1.

21. A process for controlling the crystallisation of a triglyceride, the process comprising the steps of:
(i) providing a triglyceride; and
(ii) contacting the triglyceride with the composition of claim 1.

22-28. (canceled)

29. A composition according to claim 1 wherein the monoglycerides and diglycerides have an iodine value of from 30 to 90.

30. A composition according to claim 1 wherein the fatty acids of the monoglycerides and diglycerides contain C22 fatty acids in an amount of from 4.5 to 90 wt % based on the total amount of fatty acids of the monoglycerides and diglycerides.

31. A composition according to claim 29 wherein the fatty acids of the monoglycerides and diglycerides contain C22 fatty acids in an amount of from 4.5 to 90 wt % based on the total amount of fatty acids of the monoglycerides and diglycerides.

32. The food or feed according to claim 13 comprising the composition of claim 22.

33. The food or feed according to claim 12 comprising the composition of claim 30.

34. The food or feed according to claim 12 comprising the composition of claim 31.

35. A composition according to claim 29 wherein the fatty acids of the monoglycerides and diglycerides comprise saturated C22 fatty acid.

36. A composition according to claim 30 wherein the fatty acids of the monoglycerides and diglycerides comprise saturated C22 fatty acid.

37. A composition according to claim 31 wherein the fatty acids of the monoglycerides and diglycerides comprise saturated C22 fatty acid.
